(19) United States
(12) Patent Application Publication
(10) Pub. No.: US 2008/0003215 A1
(43) Pub. Date: Jan. 3, 2008

(54) Use of pre-dissolved pristinamycin-type and polyether ionophore type antimicrobial agents in the production of ethanol

(76) Inventor: Dennis P. Bayrock, Saskatoon (CA)

Correspondence Address: HAYDEN STONE, PLLC, 101 NORTH COLUMBUS ST., SUITE 409, ALEXANDRIA, VA, 22301, US

(21) Appl. No.: 11/806,591

(22) Filed: Jun. 1, 2007

Related U.S. Application Data
(60) Provisional application No. 60/812,965, filed on Jun. 13, 2006.

(51) Int. Cl. A01N 63/02; A01N 37/18; A01P 1/00; A01N 43/16

(52) U.S. Cl. 424/115; 514/460; 514/9

(57) ABSTRACT

A method of controlling microorganisms such as lactobacilli metabolism in mash in an ethanol production facility includes adding to the mash an effective amount to control such microorganisms of one or more of a substantially water insoluble pristinamycin-type antimicrobial agent, a substantially water insoluble polyether ionophore antimicrobial agent, or both, wherein the term “substantially water insoluble” means the antimicrobial agent has a solubility in pure water at 20° C of 0.1 grams per liter or less, and wherein at least a portion of the substantially water insoluble antimicrobial agent(s) is added to the mash in the form of: 1) an organic liquid comprising at least one organic solvent having said substantially water insoluble antimicrobial agent(s) dissolved therein, said organic liquid advantageously comprising more than 1 gram per liter of said antimicrobial agent(s); 2) particles comprising said substantially water insoluble antimicrobial agent(s) and having a weight mean average diameter of less than 5 microns; or 3) both.

### CROSS-REFERENCE TO RELATED APPLICATIONS

This application claims priority to U.S. Provisional application No. 60/812,965 filed Jun. 13, 2006, the entire document of which is incorporated by reference herein for all purposes.

### STATEMENT REGARDING FEDERALLY SPONSORED RESEARCH OR DEVELOPMENT

N/A.

### INCORPORATION-BY-REFERENCE OF MATERIAL SUBMITTED ON A COMPACT DISC

N/A.

### SEQUENCE LISTING

N/A.

### FIELD OF THE INVENTION

The present invention relates to the use of delivery systems to deliver antimicrobial agents, and particularly pristinamycin-type antimicrobial agents, polyether ionophore-type antimicrobial agents, or both, to fluid compositions in industrial processes, particularly to mashes or feed solutions used in alcohol production via fermentation, in a pre-solubilized form where such antimicrobial agents are available to control undesirable organisms such as lactobacilli immediately or in a short period of time. At least a portion of the antimicrobial agent(s) are advantageously added in a dissolved form, for example dissolved in an organic solvent or in a mixture of solvents, where aprotic solvents are preferred. This novel method of adding pristinamycin-type antimicrobial agents, polyether ionophore-type antimicrobial agents, or both, to fluid compositions in industrial processes allows for new uses, including: 1) new dosing regimens for large tanks such as fermentators where such agents are traditionally added; 2) quick (under six hours) eradication of viable lactobacilli; 3) eradication of established biomasses containing undesired microorganisms, and for controlled pulse treatments of limited areas of a plant including for example heat exchangers. Additionally, additions of quickly available biocidal agents provide desired activity even in poorly stirred reaction vessels where traditional powdered biocidal agents are substantially ineffective.

### BACKGROUND OF THE INVENTION

Ethanol production through anaerobic fermentation of a carbon source by the yeast Saccharomyces cerevisiae is one of the best known biotechnological processes and accounts for a world production of more than 35 billion liters per year. Two thirds of the production is located in Brazil and in the United States with the primary objective of using ethanol as a renewable source of fuel. Hence, there are strong economic incentives to further improve the ethanol production process. The price of the sugar source or carbohydrate source is a very important process parameter in determining the overall economy of ethanol production. Using unaltered yeasts, the greatest yield obtainable is only about 51.1%, with the remainder being lost to yeast maintenance and growth, glycerol production, and other end products. The typical ethanol yield is lower than the above-described maximum theoretical yield in large part due to competing microorganisms.

A typical ethanol production plant comprises a premixing vessel where water and the carbohydrate fuel source (hereafter referred to as mash) are held at 40° C. to 60° C. and where (if corn is the source of carbohydrate) a small amount of enzyme such as a-amylase is added. The mash is then heated to between 90° C. to 150° C. for a period of time, and then cooled and held between 80° C. to 90° C. as the mash liquifies. The mash is then cooled to 60° C. and additional enzymes may be added in a saccharification step. After a period of time at 60° C., the mash is cooled to ambient to ˜35° C., and the liquid is then sent to fermenters where yeast is added to convert sugars to ethanol. In a continuous process utilization of a number of serially linked fermenters is typical, as this is required for efficient conversion of the sugars and also because ethanol-production-favorable conditions (which depend on the amount of alcohol and other byproducts present in the mash) can be optimized. Finally, the alcohol/water fraction is sent to a distilling column where alcohol is extracted, and the residual material find large markets in the animal feed business. Large volumes are processed, and as one might imagine with all the temperature changes involved in the process that heat exchangers are critical to both net production of energy and to the economics of the process.

One particularly difficult problem is the control of competing microorganisms, in particular Lactobacillus spp., which compete with the yeast for nutrients and produce lactic acid. Other microorganisms such as Acetobacter/Gluconobacter and wild yeasts must also be controlled. Since control of lactobacilli is critical to the process viability and since control of one class of microorganisms by the methods described here results in control of at least some of the other microorganisms, this discussion will focus on lactobacilli control. One of skill in the art will know that a number of other competing microorganisms will also be controlled by the treatment processes described here, depending on the antibiotics and antimicrobials used in the process. Lactobacilli contamination in the range of 10⁶ to 10⁷ per ml can reduce ethanol yield by 1-3%. Lactobacilli are present in all incoming carbohydrate sources, and are present in all areas of the ethanol production plant. In industrial processes such as the manufacture of ethanol for fuel, even with active control programs to control the proliferation of lactobacilli, carbohydrate losses to lactobacilli can range up to several percent of the total carbohydrate input, which can make the difference between profitability and non-profitability. Further, if the lactic acid content of the mash approaches 0.8% and/or acetic acid concentration exceeds 0.05%, the ethanol producing yeast are stressed and yeast metabolism is reduced. In the manufacture of certain alcoholic beverages, the proliferation of lactobacilli and its byproducts can unfavorably alter the taste and value of the product.

One very effective control program involves the introduction of pristinamycin-type antimicrobial agents, and particularly virginiamycin, to the process. These pristinamycin-type antimicrobial agents, and particularly virginiamycin, are preferred because: 1) they are very effective against a number of microorganisms including lactobacilli at low concentrations, e.g., 0.3 to 5 ppm, 2) microorganisms do not tend to develop resistance to this type of antimicrobial agent, 3) the antimicrobial agent does not significantly hinder the yeast, and 4) the antimicrobial agent is effectively destroyed by the drying of the end “waste” product so that it is not introduced indiscriminately into the environment. Usually, the “waste” byproduct, known as “Dried Distillers Grains with Solubles (DDGS), is sold as animal feed, going 45% to dairy, 35% to beef, 15% to swine, and 5% to poultry industries. This is an important factor in the profitability of an ethanol production process, and the total amount of this byproduct produced per year is on the order of 3.5 million metric tons per year. The presence of residual antimicrobial agents in this material can adversely affect the value of this byproduct, as small residual amounts of antimicrobial agents in feed will promote the development of agent-resistant microorganisms. We have tested DDGS samples from 8 major ethanol producers using virginiamycin to control microorganisms and found no detectable amount of virginiamycin in the DDGS (<1 ppm via the validated Eurofins analysis and <1 ppb via an unvalidated experimental analytical procedure). Incidentally, animal feed is often supplemented with virginiamycin, which has been shown to significantly increase production when used in a number of animal feeds. Generally, however, the virginiamycin in mash is destroyed by drying so virginiamycin must be re-added to the feed if so desired. Other effective control agents include polyether ionophore-type antimicrobial agents, which provide many of the benefits obtained with pristinamycin-type antimicrobial agents. Other control agents used in the industry include tetracycline-based antibiotics, streptomycin, penicillin-based antibiotics (e.g., G, V, or N), and bacitracin. These are not favored because microorganisms can quickly develop tolerances and presence of microorganisms that are resistant to these antibiotics can create problems with the public perception and with some uses of the waste or residual material after fermentation as animal feed. In tests with virginiamycin, a mixture of ˜70-75% penicillin/10-15% virginiamycyn/10-15% streptomycin, and “KPenG” a commercial product, we found L. plantarum developed resistance to KPenG in about 2 weeks, and developed resistance to the mixture in about a week, but showed no development of resistance to virginiamycin over the entire 10 week duration of the test. Further, penicillin and streptomycin are partially inactivated at the pH in the fermenters. Also, there are issues with worker safety and allergies.

It has been demonstrated that for antibiotics such as penicillin that pulsed addition of antibiotics is significantly superior compared to continuous addition of the same amount of antibiotic. See, e.g., Control of Lactobacillus contaminants in continuous fuel ethanol fermentations by constant or pulsed addition of penicillin G, Appl Microbiol Biotechnol (2003) 62:498-502 by Bayrock, Thomas, and Ingledew. This is believed to extend to other types of antimicrobial agents. We have tested pulsed dosing versus continuous dosing on L. paracasei and found pulse dosing lowered the microorganism count to about 30% of the value obtained with continuous dosing, where the same amount of antimicrobial agent is added in both cases. It is generally known that higher concentrations of antimicrobial agents result in higher numbers of targeted microorganisms being destroyed than are destroyed at lower concentrations. Pulsed mode addition of antimicrobial agents is believed to be more effective than continuous treatment because the higher concentration (even if present for only a short time) reduces the number of targeted microorganisms sufficiently that the rebound of surviving targeted microorganisms during periods between treatments results in fewer total viable microorganisms (averaged over time) than are obtained by continuous treatment with the same quantity of antimicrobial agent.

The processes and materials of this invention are particularly useful to introduce antimicrobial agents having very low solubility in water, e.g., a solubility of less than about 10⁻² and often less than about 10⁻³ grams per liter in water. The solubility of monensin, virginiamycin, and similar pristinamycin-type antimicrobial agents and polyether ionophore-type antimicrobial agents in water is very low. Pristinamycin-type antimicrobial agents, especially virginiamycin, have extremely low solubility in water (e.g., 0.0001 grams/l), and additionally the kinetics of dissolution are very poor. Similarly, polyether ionophores have extremely low solubility in water.

The typical treatment of ethanol plants with pristinamycin-type antimicrobial agents or polyether ionophores is provided by intermittently adding powders either as loose material or encased in dissolvable bags or packets containing a predetermined amount of the antimicrobial agent to one or more of the large mixed tanks. Two commercial prior art formulations used in ethanol treatment plants of virginiamycin comprised powder of average diameter of 5.2 to 10 microns and about 1000 microns, respectively. We have found that an impeding factor in controlling pests such as lactobacilli is the rate of dissolution of small granular pristinamycin-type antimicrobial agents and polyether ionophore-type antimicrobial agents in water or mash. A 0.1 gram sample of a 5.2 to 10 micron average particle size virginiamycin was placed in a beaker with 4 liters of water, and the composition was continuously and vigorously stirred. It took on the order of an hour before only a few crystals of the material remained visible. Such slow dissolution will reduce effectiveness of pulse treatments as it takes a long time for the added agents to become solubilized and effective, and will reduce the highest concentration of added agents resulting from a pulsed addition in continuous processes as some of the agent may be removed from the fermentator or other tank before the maximum amount of added agent is solubilized, and because some added agent may not dissolve at all.

In these large mixed tanks, there is often sufficient residence time and mixing for some portion of the virginiamycin to dissolve. However, mash vats and other large tanks in ethanol production plants typically are not rigorously and completely stirred, as the energy needed for such mixing can outweigh small gains in the yeast efficiency. In a poorly mixed environment, we have determine dissolution rates can take many hours, and some fraction of a granular pristinamycin-type antimicrobial agent and/or polyether ionophore-type antimicrobial agent product may never be solubilized and thereby activated. Even introduction of virginiamycin in powdered form into vigorously stirred mixing tanks containing alcoholic mash does not result in complete dissolution of the antimicrobial agent, and solid antimicrobial agent material that does not dissolve is wasted.

### SUMMARY OF THE INVENTION

The invention can be broadly described as a method of controlling undesired microorganism (e.g., lactobacilli) metabolism in mash in an ethanol production facility, comprising adding to the mash an effective amount of one or more of a substantially water insoluble pristinamycin-type antimicrobial agent, a substantially water insoluble polyether ionophore antimicrobial agent, or both, wherein the term “substantially water insoluble” means the antimicrobial agent has a solubility in pure water at 20° C. (ambient) of about 0.1 grams per liter or less, and wherein at least a portion of the substantially water insoluble antimicrobial agent(s) is added to the mash in the form of an organic solution comprising at least one organic solvent having said substantially water insoluble antimicrobial agent(s) dissolved therein, said organic solution advantageously comprising at least 1 gram per liter, preferably at least 2 grams per liter, for example at least 10 or 50 grams per liter, of said antimicrobial agent(s).

In one embodiment the substantially water insoluble antimicrobial agent comprises, consists essentially of, or consists of a substantially water insoluble pristinamycin-type antimicrobial agent. In another embodiment the substantially water insoluble antimicrobial agent comprises or consists essentially of a substantially water insoluble polyether ionophore antimicrobial agent. In one preferred embodiment the substantially water insoluble antimicrobial agent comprises or consists essentially of at least one of virginiamycin and semduramycin and at least a portion of the antimicrobial agent(s) is added to the mash in the form of an organic liquid comprising at least one organic solvent having said substantially water insoluble antimicrobial agent(s) dissolved therein. By “organic liquid” or “organic solution” we mean a liquid which preferably comprises at least 50% by weight of one or more organic solvents. In another embodiment the substantially water insoluble antimicrobial agent comprises or consists essentially of monensin and at least a portion of the monensin is added to the mash in the form of an organic liquid comprising at least one organic solvent having said monensin dissolved therein.

In a preferred embodiment the substantially water insoluble antimicrobial agent comprises, consists essentially of, or consists of a substantially water insoluble pristinamycin-type antimicrobial agent, and at least a portion of said pristinamycin-type antimicrobial agent is added to the mash in the form of an organic solvent-containing liquid comprising more than 10 grams per liter, preferably more than 50 grams per liter, more preferably more than 100 grams per liter, of solubilized pristinamycin-type antimicrobial agent. In another embodiment the substantially water insoluble antimicrobial agent comprises a substantially water insoluble pristinamycin-type antimicrobial agent, and at least a portion of said pristinamycin-type antimicrobial agent is added to the mash in the form of an organic solvent-containing liquid comprising at least one dipolar aprotic organic solvent, said organic liquid comprising more than 10 grams per liter, preferably at least 50 grams per liter, more preferably more than 100 grams per liter, of pre-solubilized pristinamycin-type antimicrobial agent. In another embodiment the substantially water insoluble antimicrobial agent comprises, consists essentially of, or consists of a substantially water insoluble pristinamycin-type antimicrobial agent which is added to an aqueous solution or mash in the form of an organic liquid, wherein the organic liquid preferably comprises at least one dipolar aprotic organic solvent, said organic liquid comprising more than 10 grams per liter, preferably at least 50 grams per liter, more preferably more than 100 grams per liter, of said pristinamycin-type antimicrobial agent.

In another preferred embodiment the substantially water insoluble antimicrobial agent comprises, consists essentially of, or consists of a substantially water insoluble polyether ionophore-type antimicrobial agent, and at least a portion of said antimicrobial agent is added to the mash in the form of an organic solvent-containing liquid comprising more than 10 grams per liter, preferably more than 50 grams per liter, more preferably more than 100 grams per liter, of solubilized antimicrobial agent. In another embodiment the substantially water insoluble antimicrobial agent comprises, consists essentially of, or consists of a substantially water insoluble polyether ionophore-type antimicrobial agent, and at least a portion of said antimicrobial agent is added to the mash in the form of an organic solvent-containing liquid comprising at least one dipolar aprotic organic solvent, said organic liquid comprising more than 10 grams per liter, preferably at least 50 grams per liter, more preferably more than 100 grams per liter, of pre-solubilized antimicrobial agent. In another embodiment the substantially water insoluble antimicrobial agent comprises, consists essentially of, or consists of a substantially water insoluble polyether ionophore-type antimicrobial agent which is added to an aqueous solution or mash in the form of an organic liquid, wherein the organic liquid preferably comprises at least one dipolar aprotic organic solvent, said organic liquid comprising more than 10 grams per liter, preferably at least 50 grams per liter, more preferably more than 100 grams per liter, of said antimicrobial agent.

In another embodiment the substantially water insoluble antimicrobial agent comprises, consists essentially of, or consists of a substantially water insoluble polyether ionophore antimicrobial agent, and at least a portion of said antimicrobial agent is added to the mash in the form of an liquid comprising one or more of at least one dipolar aprotic organic solvent, at least one alkyl acetate, at least one alkyl lactate, or combination thereof, said organic liquid comprising more than 1 gram per liter, preferably more than 2 grams per liter, more preferably more than 10 grams per liter, for example at least 50 grams per liter of said antimicrobial agent. In another embodiment at least a portion of said antimicrobial agent is added to the mash in the form of an organic liquid comprising at least one dipolar aprotic organic solvent, at least one alkyl acetate, at least one alkyl lactate, or combination thereof, said organic liquid comprising more than 1 gram per liter, preferably more than 2 grams per liter, more preferably more than 10 grams per liter, for example at least 50 grams per liter of said antimicrobial agent. In any of the embodiments herein at least a portion of said antimicrobial agent can be added to the mash in the form of an organic liquid comprising at least one of alkyl acetate where the alkyl moiety has between 1 and 4 carbon atoms, alkyl lactate where the alkyl moiety has between 1 and 4 carbon atoms, N,N-dialkylcapramide where the alkyl moiety has between 1 and 4 carbon atoms, a sulfoxide, an alkylsulfoxide and/or a dialkylsulfoxide where the alkyl moiety has between 1 and 4 carbon atoms, N-alkylpyrrolidone where the alkyl moiety has between 1 and 4 carbon atoms, pyrrolidone, alkyl formamide and/or dialkyl formamide where the alkyl moiety has between 1 and 4 carbon atoms, acetone, isopropanol, a butanol, a pentanol, or combinations thereof. In another embodiment at least a portion of said antimicrobial agent is added to the mash in the form of an organic liquid comprising at least 70% by weight of ethanol in water. In another embodiment at least a portion of said antimicrobial agent is added to the mash in the form of an organic liquid comprising at least one dipolar aprotic organic solvent, at least one alkyl acetate, at least one alkyl lactate, or combination thereof, said organic liquid advantageoulsy comprising more than 20 grams per liter of said antimicrobial agent. In another embodiment the substantially water insoluble antimicrobial agent comprises a substantially water insoluble pristinamycin-type antimicrobial agent, and at least a portion of said pristinamycin-type antimicrobial agent is added to the mash in the form of an organic liquid comprising at least one alkyl acetate or alkyl lactate wherein the alkyl moiety contains between 1 and 4 carbon atoms. In another embodiment the substantially water insoluble antimicrobial agent comprises a substantially water insoluble pristinamycin-type antimicrobial agent, and wherein at least a portion of said pristinamycin-type antimicrobial agent is added to the mash in the form of an organic liquid comprising a C1 to C4 alkyl ester of low molecular weight organic acids, for example particularly ethyl acetate, ethyl lactate, or both. In another embodiment at least a portion of said antimicrobial agent is added to the mash in the form of an organic liquid comprising a pyrrolidone, an amide, or a sulfoxide. In another embodiment at least a portion of said antimicrobial agent is added to the mash in the form of an organic liquid comprising at least 200 grams of said dissolved antimicrobial agent per liter of said organic solvent. In another embodiment at least a portion of said antimicrobial agent is added to the mash in the form of an organic liquid having a closed cup flash point of greater than 200° F.

In another embodiment at least a portion of said antimicrobial agent is added to the mash as a composition comprising particles comprising said substantially water insoluble antimicrobial agent(s), said composition being in the form of a slurry comprising particles and any of the organic liquids or liquids comprising the antimicrobial agents that were described in the many embodiments above.

In another embodiment the ethanol production facility comprises a tank having an inlet and an outlet and a heat exchanger having an inlet and an outlet and being flowingly connected to the outlet of said tank so mash flows from the tank to the heat exchanger, the method comprising adding to the mash at a point between the tank outlet and the outlet of the heat exchanger an effective amount of said substantially water insoluble antimicrobial agent in the form of an organic liquid comprising at least one organic solvent having said substantially water insoluble antimicrobial agent(s) dissolved therein, said organic liquid comprising more than 1 gram per liter, preferably more than 10 grams per liter of said antimicrobial agent(s).

In another embodiment at the ethanol production facility comprises at least one heat exchanger, said method comprising adding at least a portion of said antimicrobial agent to said mash passing through said heat exchanger. In another embodiment the ethanol production facility comprises at least one mixed tank and at least one heat exchanger, the method comprising:
a) adding to the mash in said tank a portion of the substantially water insoluble antimicrobial agent(s); and
b) adding to the mash passing through said heat exchanger a portion of the substantially water insoluble antimicrobial agent(s) in the form of an organic liquid comprising at least one organic solvent having said substantially water insoluble antimicrobial agent(s) dissolved therein, said organic liquid comprising more than 1 gram per liter of said antimicrobial agent(s).

In another embodiment at least a portion of said antimicrobial agent is added to the aqueous composition such as the mash by a metering pump which pumps a liquid composition comprising said antimicrobial agent into said mash.

The formulations discussed above are useful for a variety of applications in addition to controlling undesired microorganisms in ethanol production facilities. Antimicrobial agents such as virginiamycin are used in a large number of applications, including the above-mentioned use as a supplement given to animals to encourage growth. The compositions of this invention are active in mash vats and other large tanks in ethanol production plants that are not rigorously and completely stirred, where powdered agents are substantially ineffective. Liquid compositions of this invention can also be sprayed onto surfaces of the process equipment which are only intermittently wetted by for example mash, for example in upper parts and tops of tanks and fermentors, where the liquid can dry and leave a small but antimicrobially effective amount of antimicrobial agents which will discourage formation of undesired biomass resulting from occasional and often accidental wetting by mash or other nutrient-rich liquid. In a poorly mixed environment, dissolution of added powders can take many hours, and some fraction of a granular pristinamycin-type antimicrobial agent and/or polyether ionophore-type antimicrobial agent product may never be solubilized and thereby activated. The solutions and slurries of various embodiments of this invention (using appropriate solvents) are equally applicable to use in those fields of use, providing a number of benefits including reduced dust, easy incorporation of antimicrobial agents into feed, and greater stability and dispersability in water systems.

### BRIEF DESCRIPTION OF THE DRAWINGS

The drawings show data from a number of experiments as described below:

FIG. 1 shows the Lactobacillus count versus time in mash from the well-mixed fermentators treated with Lactrol™ (Brazil) brand powdered virginiamycin, Lactrol™ (Belgium) brand powdered virginiamycin, or virginiamycin solubilized in dimethylsulfoxide (DMSO) according to this invention, and also the Lactobacillus count in a well-mixed control fermentator.

FIGS. 2 and 3 show (for duplicate experiments) the Lactobacillus count versus time in mash from the poorly-mixed fermentators treated with Lactrol™ (Brazil) brand powdered virginiamycin, Lactrol™ (Belgium) brand powdered virginiamycin, or virginiamycin solubilized in DMSO according to this invention, and in a poorly-mixed control fermentator.

FIGS. 4 and 5 show Yeast #1 viability in corn mash containing 0 to 200 ppm DMSO and 0 to 1000 ppm DMSO, respectively.

FIGS. 6 and 7 show glycerol production from Yeast #1 in corn mash containing 0 to 200 ppm DMSO and 0 to 1200 ppm DMSO, respectively.

FIGS. 8 and 9 show ethanol production from Yeast #1 in corn mash containing 0 to 200 ppm DMSO and 0 to 1200 ppm DMSO, respectively.

FIGS. 10 and 11 show Yeast #1 viability in corn mash containing 0 to 200 ppm NMP and 0 to 1200 ppm NMP, respectively.

FIGS. 12 and 13 show glycerol production from Yeast #1 in corn mash containing 0 to 200 ppm NMP and 0 to 1200 ppm NMP, respectively.

FIGS. 14 and 15 show ethanol production from Yeast #1 in corn mash containing 0 to 200 ppm NMP and 0 to 1200 ppm NMP, respectively.

FIG. 16 shows Yeast #2 viability in corn mash containing 0 to 1200 ppm DMSO.

FIG. 17 shows glycerol production from Yeast #2 in corn mash containing 0 to 1200 ppm DMSO.

FIG. 18 shows ethanol production from Yeast #2 in corn mash containing 0 to 1200 ppm DMSO.

FIG. 19 shows Yeast #2 viability in corn mash containing 0 to 1200 ppm NMP.

FIG. 20 shows glycerol production from Yeast #2 in corn mash containing 0 to 1200 ppm NMP.

FIG. 21 shows ethanol production from Yeast #2 in corn mash containing 0 to 1200 ppm NMP.

### DETAILED DESCRIPTION OF PREFERRED EMBODIMENTS

One aspect of this invention is to supply a single-phase liquid comprising one or more of dissolved antimicrobial agents, particularly pristinamycin-type antimicrobial agents, polyether ionophore-type antimicrobial agents, or both, to mash or to an ingredient forming the mash in an ethanol production plant, where the pre-dissolved pristinamycin-type antimicrobial agents, polyether ionophore-type antimicrobial agents, or both are added in a continuous mode, in a pulsed mode, or in some alternative hybrid mode. The liquid comprising the dissolved antimicrobial agents advantageously comprises a single phase, as stability problems associated with emulsions are absent. The liquid containing the dissolved pristinamycin-type antimicrobial agents, polyether ionophore-type antimicrobial agents, or both comprises at least about 1 gram of antimicrobial agent per liter, for example at least 5 grams of antimicrobial agents per liter, more preferably at least 10 grams of antimicrobial agents per liter, even more preferably at least 20 grams or at least 50 grams of antimicrobial agents per liter, and most preferably at least 100 grams or more of antimicrobial agents per liter.

Preferred solvents and solvent mixtures are those that exhibit both very low to negligible adverse impacts on yeast and on the byproduct DDGS (in the amounts necessary to solubilize and deliver the required dosage of antimicrobial agent), and that solubilize more than 50 grams of virginiamycin (or other pristinamycin-type antimicrobial agents, polyether ionophore-type antimicrobial agents, or both) per liter, preferably more than 100 grams per liter, more preferably at least 150 grams of virginiamycin (or other pristinamycin-type antimicrobial agents, polyether ionophore-type antimicrobial agents, or both) per liter. Generally, both pristinamycin-type antimicrobial agents and polyether ionophore-type antimicrobial agents exhibit solubility in polar organic solvents. Some preferred solvents include dipolar aprotic solvents, for example pyrrolidones such as N-methylpyrrolidone (NMP), amides such as dimethyl formamide and sulfoxides such as dimethyl sulfoxide (DMSO), can dissolve 100 or more grams virginiamycin per liter. For example, we found NMP could dissolve about 290 grams of virginiamycin per liter over a short period of time, and a time stable formulation could be made that contained between 250 and 270 grams of virginiamycin per liter of NMP. Literature data suggests 200 grams of virginiamycin can be dissolved in dimethylsulfoxide or in dimethylformamide. The liquid comprising the dissolved pristinamycin-type antimicrobial agents, polyether ionophore-type antimicrobial agents, or both may advantageously comprise more than one solvent, for example comprising two or more solvents, where preferably at least one solvent is a dipolar aprotic solvent.

Dipolar aprotic solvents may not be useful in for example plants that manufacture ethanol-containing products for human consumption. Technical grade of solvents is often preferred if the ethanol is being used for fuel, as high purity is often not required, and the solvents will metabolized or recovered in the ethanol/gasoline formulation. For ethanol as a beverage, advantageously the solvent is added in a more pure form, and the solvent is a material naturally found in the beverage product, or the solvent is most preferably consumed by yeast or otherwise treated so as not to enter the beverage. In plants producing ethanol for human consumption, the preferred solvents are those that solubilize more than 1 gram, and preferably more than 20 grams, of antimicrobial agent per liter, and are consumed by yeast, are naturally present in the beverage, have low toxicity, and/or are eliminated from the beverage by further processing. A useful polar organic solvent is ethanol with water, where a reasonably high concentration (˜70 g/l) of pristinamycin-type antimicrobial agents (e.g. virginiamycin) and somewhat similar amounts of polyether ionophore-type antimicrobial agents can be dissolved if the liquid is at least 75% by weight ethanol (balance water). A problem with pre-solubilized liquid compositions is the presence of highly flammable mixtures—ethanol has a flash point of about 55° F. One or more propanols may be useful if the ethanol will be used for fuel. Other useful solvents include C₄ and higher alcohols or polyalcohols, for example butanols, pentanols, and the like, which when admixed with water may not be immediately miscible with the water. Again, these solvents have flash points of between about 60° F. and 90° F. and are flammable.

Alkane solvents are not useful for many of the antimicrobial agents, e.g., virginiamycin, used in this invention.

Certain C₁ to C₅, preferably C₁ to C₄ alkyl esters of low molecular weight (C₁ to C₄, preferably C₂ to C₃) organic acids, particularly alkyl acetates, propionates, butyrates, lactates, and the like are also known to be benign in terms of yeast and human exposure, and the preferred antimicrobial agents of this invention all exhibit significant solubility in these solvents. Therefore, advantageously the alkyl moiety in the alkyl acetates, alkyl lactates, and the like is advantageously C₁ to C₄, and is preferably is ethyl. Exemplary solvents include ethyl lactate, ethyl acetate, ethyl 2-hydroxyacetate, and the like. Inclusion of hydroxyl groups onto the alkyl moiety or acid moiety are useful. So-called “green” solvents, which have little effect on humans in reasonable concentrations, are preferred. Such solvents typically have LD50 concentrations (for rats, rabbits, and other test animals) of at least 5 grams per kilogram. Many such compounds are used in the food industry. Not all C₁ to C₄ alkyl esters of low molecular weight organic acids are preferred. Some solvents, such as n-butyl lactate, are classified as a poison by intraperitoneal route and toxic concentration in air for humans is about 4 ppm. A preferred solvent is ethyl lactate, CH₃CH(OH)CO₂C₂H₅ which we have found can dissolve about 92 grams of virginiamycin per liter. Ethyl lactate is a “green” solvent used in flavorings and perfumes, for example, and ethyl lactate is derived from processing corn—the only down-sides to ethyl lactate are its intermediate solubilizing power (90 g/L) and that it is still a flammable solvent having a flash point of 117° F. Adding large non-polar moieties to alkyl esters of low molecular weight (C₂ to C₄) organic acids is not useful—ethyl hexyl lactate does little to improve biodegradability, flash point depression, or solubility (only 24 grams virginiamycin per liter) and this solvent is therefore less preferred than ethyl lactate. On the other hand, admixing C₁ to C₄ alkyl esters of low molecular weight (C₂ to C₄) organic acids with one or more dipolar aprotic solvents can provide a surprisingly high solubility while minimizing the impact of the solvent on yeast, the product, and the byproduct. Ethyl acetate (ethyl ethanoate), used for decaffinating coffee and for flavorings, is also a very useful benign solvent exhibiting good solubility of the antimicrobial agents used in this invention. Amyl acetate, while fairly benign, has a useful solubilizing effect for monensin but the solubility of virginiamycin in this solvent is at the lower end of what is commercially feasible.

Sulfoxides and sulfones are useful solvents for solubilizing the antimicrobial agents. The term “sulfoxide” as used herein is represented by the formula R1SOR2, where R1 and R2 can be, independently, an alkyl, halogenated alkyl, alkenyl, alkynyl, aryl, heteroaryl, cycloalkyl, cycloalkenyl, heterocycloalkyl, or heterocycloalkenyl group, and preferably each R1 and R2 comprises between 1 and 4 carbon atoms. The term “sulfone” as used herein is represented by the formula R1SO2R2, where R1 and R2 can be, independently, an alkyl, halogenated alkyl, alkenyl, alkynyl, aryl, heteroaryl, cycloalkyl, cycloalkenyl, heterocycloalkyl, or heterocycloalkenyl group, and preferably each R1 and R2 comprises between 1 and 4 carbon atoms. Throughout the specification “alkyl” is generally used to refer to both unsubstituted alkyl groups and substituted alkyl groups. Certain related compounds such as benzyl acetate are useful for solubilizing certain antimicrobial agents of this invention.

Advantageously, the flammability of the solvent is such that the compositions of this invention can be used in an ethanol-producing plant without special labeling and handling. There are stringent rules relating to the presence of flammable solvents in additives and chemicals stored in ethanol production plants. For example, use of 90% ethanol in upstream processes is tightly restricted, despite the product of the plant being for example 90% ethanol. Generally material with a flash point of 200° F. or above is often considered to be non-combustible, though the federal, state, and local regulations relating to ethanol production facilities may have different definitions of flammable and restricted solvents. A preferred solvent is 2-pyrrolidone with a flash point of 265° F. Another preferred solvent is dimethylsulfoxide having a flash point of 203° F. NMP is a preferred solvent in terms of solubility versus health and safety issues, but it has a flash point of 199° F. One preferred solvent system is a mixture of solvents comprising NMP and one or more of dimethylsulfoxide or 2-pyrrolidone, where the formulation may further comprise water, and where the composition has a flash point of about 201° F. or higher and be considered non-combustible while solubilizing 150 to 250 grams virginiamycin per liter.

In an alternate embodiment, the liquid comprises between 5 and 25% by weight ethanol, for example between 15 and 24.9% by weight ethanol with the balance water. Generally, such solutions have an extremely limited solubility of the desired antimicrobial agents, for example less the 1 gram per liter. Concentrations of ethanol higher than 25% are increasingly effective at solubilizing either or both of monensin and virginiamycin, and high solubility is obtained at 75% ethanol, but such solutions require special permitting and handling in ethanol production plants. As used herein, when we discuss monensin we are talking about either Monensin type A alone, monensin comprising a majority of type A and one or more of types B, C, and D, and “monensin sodium.” As used herein, when we discuss virginiamycin we are talking about a formulation containing virginiamycin type A, virginiamycin type B, or very preferably a combination of the two.

Advantageously, the solvents must have a sufficiently high concentration of antimicrobial agent and must not (at the anticipated concentrations of the solvent in the fermentors) adversely affect yeast. Typically, sufficient control of lactobacilli is obtained in the tanks, fermentors, and the like with between 0.2 ppm to 1 ppm, and typically between 0.3 ppm and 0.4 ppm antimicrobial agent, preferably virginiamycin (though occasionally a spike of up to 3 or 4 ppm or so may be necessary under some conditions). Treatment with polyether ionophores usually requires between 0.3 ppm to 3 ppm, and typically between 0.5 ppm and 2 ppm polyether ionophore. Further, plants are sized that for most applications a “dose” of virginiamycin sufficient to treat a large mixed tank is between one ounce and one pound of active ingredient. Assuming a dipolar aprotic solvent density of 1 g/cc, a liquid having 200 grams per liter of dissolved antimicrobial agent, e.g., virginiamycin, will need to be added at a rate of 1.5 to 2 ppm liquid into the mash to provide the desired 0.3 ppm to 0.4 ppm concentration of antimicrobial agent. Further, the normal dosage of 1 ounce to one pound for dosing of large mixed tanks would require between about 140 ml and 2500 ml of liquid, which is an easy volume to ship, store, and handle. For the solvents used to formulate this 200 g/l product, if all treatments of the mash are solubilized virginiamycin (or other pristinamycin-type antimicrobial agents, polyether ionophore-type antimicrobial agents, or both), the solvent or solvents used to solubilize the antimicrobial agents must not adversely affect yeast or the byproduct feed material when present in amounts of for example up to about 5 ppm. If the solubilized pristinamycin-type antimicrobial agents, polyether ionophore-type antimicrobial agents, or both are only used for spotted pulse treatments of selected equipment, for example heat exchangers, the amount of solvent in the mash will more likely be well below 1 ppm. On the other hand, if the solvent can only solubilize 1 gram of antimicrobial agent, e.g., virginiamycin, per liter, then the operator will need to add the liquid at a rate of 300 to 400 ppm liquid into the mash to provide the desired 0.3 ppm to 0.4 ppm concentration of antimicrobial. To be useful, these solvents used to formulate the liquid having 1 gram dissolved antimicrobial agent per liter should not adversely affect yeast at concentrations of up to about 500 ppm. Further, the normal dosage of 1 ounce to one pound for dosing of large mixed tanks would require between about 29 liters and 460 liters of liquid, which is an extremely difficult volume to ship, store, and handle. Finally, the cost of the solvent(s) used impacts feasibility, and large amounts of solvents are expensive. Generally, a liquid having only 1 gram antimicrobial agent dissolved therein per liter of liquid may not be economically practicable for use in dosing large tanks. Such a liquid can still be economically and feasibly used, however, for intermittent pulsed treatment of small volumes of mash, for example the volume of mash passing through a heat exchanger for some predetermined duration of a dose to treat the heat exchanger.

For solubilized virginiamycin embodiments of this invention, it may be useful to have a portion or all of the virginiamycin be in a modified form, such as acetylated, to increase solubility characteristics in water without effectively destroying the utility of the antimicrobial agent. Typically, disclosures herein center on virginiamycin, as that is the preferred antimicrobial agent. It should be appreciated, however, that these disclosures are also generally applicable to other pristinarnycin-type antimicrobial agents and polyether ionophore-type antimicrobial agents.

For plants producing ethanol for use as fuel, other preferred organic solvents are those that in the concentrations added are not detrimental to yeast, and which are separated from the aqueous mash in the distillation process so as to follow the ethanol, where said solvent is of the type capable of being blended into gasoline with no adverse effects. Advantageously, in some embodiments of the invention, the medium comprising the pristinamycin-type antimicrobial agents, polyether ionophore antimicrobial agents, or both does not require special permitting and handling in an ethanol plant.

Another aspect of this invention is to supply a multi-phase liquid comprising one or more of dissolved antimicrobial agents, particularly pristinamycin-type antimicrobial agents, polyether ionophore-type antimicrobial agents, or both, to mash or to an ingredient forming the mash in an ethanol production plant, where the pre-dissolved pristinamycin-type antimicrobial agents, polyether ionophore-type antimicrobial agents, or both are added in a continuous mode, in a pulsed mode, or in some alternative or hybrid mode. In this embodiment the liquid containing the dissolved pristinamycin-type antimicrobial agents, polyether ionophore-type antimicrobial agents, or both can be supplied as a two-phase liquid, for example as an oil (or solvent) phase of an oil-in-water emulsion. The solvents must be selected to provide limited miscibility with water, at least in amounts at which the emulsion is formed. Typically, in such an oil-in-water emulsion, most of the solvent and most of the antimicrobial agents will reside in the oil phase, though the antimicrobial agents and the solvent will both have some limited solubility in the water phase of the emulsion. Advantageously the water phase of the oil-in-water emulsion comprises at least 50% by weight water. The characteristics of the emulsion can be best described by treating the oil and water phases separately, as if the emulsion was broken and the two phases existed separately. Advantageously the solvent or “oil” fraction of the oil-in-water emulsion comprises at least 1 gram of antimicrobial agent (or antimiocrobial agent) per liter, for example at least 5 grams of antimicrobial agents per liter, more preferably at least 10 grams of antimicrobial agents per liter, even more preferably at least 20 grams grams of antimicrobial agents per liter. The amount of antimicrobial agents in the emulsion can be approximated by the amount of antimicrobial agents in the oil phase of the emulsion times the volume fraction of the emulsion is oil phase. Advantageously if the emulsion is a concentrate then at least 10%, and preferably at least 20% by volume of the emulsion is the oil phase. Generally, both pristinamycin-type antimicrobial agents and polyether ionophore-type antimicrobial agents exhibit substantial solubility in polar organic solvents. Such solvents may, however, exhibit high solubility in water. Useful solvents for emulsions include C4 and higher alcohols or polyalcohols, for example butanols, pentanols, and the like. Dipolar aprotic solvents are useful in limited amounts, even though they are very soluble in water and may concentrate primarily in the water phase. Emulsifiers typically must be added to such a composition. The advantage of an emulsion over a single phase organic liquid such as discussed previously is that an emulsion will be very resistant to fire. On the other hand, various factors affecting the commercial feasibility of such emulsion treatments are the same as for the single phase liquid treatments—the amount of treatment that must be added and the cost of the solvent becomes very large as the concentration of active ingredient goes down, the yeast must not be adversely affected by the solvent or solvents at the concentrations of those solvents that will be found in the fermentors, and solvents must not at the concentrations added affect the utility of the product. Often, the emulsions are prepared immediately prior to introducing the emulsion into the mash by imparting high shear forces to a composition comprising the organic and water phases.

We have found that prior art formulations do not provide the anticipated concentration profile when admixed into tanks, as it takes a long period of time (more than 10 minutes) for such particles to dissolve in aqueous mash, and the hydrodynamic conditions and residence time of the particles in the mixing tank are such that some of the antimicrobial material will not dissolve but will be effectively wasted. Therefore, a pulse treatment of a mixed tank in fact does not provide an active concentration of material as is often depicted in literature, that is, reaching a peak which subsequently declines as the pulse or dose is diluted by untreated incoming mash. Rather, the concentration of effective antimicrobial agents in a dosed mixed tank using prior art treatments tends to climb slowly and peaks at a point where a significant amount of the material has already left the mixed tank, and the peak concentration and the area under a concentration-time curve will both be much lower than anticipated. Using compositions of this invention, the effective dose (that is, the dose of antimicrobial agent that is effectively used to control targeted microorganisms) more nearly matches the theoretical dose. Second, higher effective concentrations (and therefore increased efficacy) of biocide are achieved from a pulse dose of the composition of this invention than is obtainable with the same mass of slow dissolving particles. Third, tailoring a pulse in terms of effective concentration versus time and the duration of a pulse can be achieved. Fourth, the compositions of this invention can be utilized to pulse treat unit operations such as heat exchangers and small mixed tanks (especially for example saccharization tanks) where treatment with prior art formulations was not practical or possible because much of the added product would be flushed from the targeted unit operations prior to dissolution. Finally, fifth, using prior art formulations only the solubilized portion of antimicrobial agents were effective. The targeted bacteria have an effective diameter of about a micron. If the antimicrobial agent precipitates from the organic liquid when the liquid is added to the mash, the precipitate will be of a size near that of a bacteria, say between ˜0.02 microns to ˜2 microns, and a measure of control is obtainable from direct solid antimicrobial agent to microorganism contact and/or interaction, thereby increasing the efficacy of a mixture of soluble and precipitated particulate biocide of the current invention as compared to the efficacy of a mixture of soluble and particulate biocide of the prior art formulations.

It is recognized that in some cases adding solubilized antimicrobial agents to mash or an excess of aqueous liquid will result in substantially instantaneously formed submicron to nanometer sized particles in a “slurry”, where the formation of particles and the resultant size of particles depends in large measure on the hydrodynamic conditions at the point the solubilized antimicrobial agents are added to the mash. Precipitating submicron particles of antimicrobial agent which in some cases might occur on mixing an organic liquid containing the agents with water or mash is more advantageous that trying to provide powdered submicron antimicrobial agents. The most significant drawback of powdered submicron antimicrobial agents is the possibility of dust, both from normal operations and from normal shipping and handling of product. Submicron particles can act much like smoke or dust in the air.

It may be useful if flow conditions are not sufficiently turbulent to add the solubilized and/or particulate antimicrobial agents to a small sidestream under high shear, where this sidestream can then be reintroduced to the mash. This mixing can be done immediately before introducing the antimicrobial agent to the mash, and can utilize high shear, or an elevated temperature, or any combination of the above as needed depending on the composition of the material containing the antimicrobial agents.

In one embodiment, the liquid phase of liquid composition or slurry comprises water and up to 25%, for example between 15% and 23%, of ethanol. This ethanol will pre-dissolve a very small portion of the antimicrobial agents from the particles, giving the injected slurry a small but almost instantaneous punch. Concentrations of ethanol higher than 25% are increasingly effective at solubilizing either or both of monensin and virginiamycin, and high solubility is obtained at 75% ethanol, but such solutions require special permitting and handling in ethanol production plants.

We have mentioned continuous treatment, pulsed treatment, and hybrid treatments. A pulsed treatment supplies a single dose of antimicrobial agent to a receiving vessel, usually a mixed tank, at regular intervals that are advantageously spaced such that the concentration of the antimicrobial agent reaches a high soon after adding the dose and then declines as the material degrades or is transported out of the tank, which will occur for example in continuous production plants. We have actually found that there is a significant period of time between adding a dose of prior art formulations and the time of the measured peak of active (dissolved) antimicrobial agent. We have further found that the actual peak of dissolved antimicrobial agent is not only more delayed from the theoretical peak but is also at a significantly lower concentration value than the theoretical concentration (assuming instantaneous delivery, mixing, and dissolution). That is, adding a 2 ppm dose of antimicrobial agent of the type used in the prior art may give a peak of for example 1.5 ppm (or even less!) of dissolved antimicrobial agent in the mash, where the main cause is undissolved antimicrobial particles and agent carried from the mixing tank prior to dissolution. Using formulations of the current invention allow active concentrations to be much closer to the theoretical concentrations. Further, the amount of antimicrobial agent in a pulse can be introduced over time, allowing the operator to extend the peak concentration for a operator-definable period of time to maximize effectiveness. This is one hybrid method of introducing one or more pristinamycin-type antimicrobial agents, polyether ionophore-type antimicrobial agents, or both to mash that was not possible using prior art formulations.

Another aspect of this invention is to supply pulsed treatments of either or both of 1) the above-described liquid comprising pre-dissolved pristinamycin-type antimicrobial agents, pre-dissolved polyether ionophores, or both, to locations upstream of a particular targeted unit operation, for example a heat exchanger or a saccharization tank in an ethanol production plant, where the pulse is not diluted by passing through a large mixed tank or the like prior to reaching the heat exchanger or saccharization tank. Of course, these unit operations can also be treated in continuous mode using the compositions of this invention, but many benefits of this invention will not be realized by continuous treatments. Adding a pulsed dose of antimicrobial agent, where the pulse is added in an amount sufficient to provide the desired concentration of active antimicrobial agent for the desired period of time, can greatly reduce heat exchanger fouling. It is extremely desirable to be able to “dose” a small volume of the mash passing through heat exchangers on a more frequent interval than is needed to treat the bulk of the product. Heat exchangers provide a very attractive location for microorganisms to proliferate, as the temperature is by the nature of heat exchangers moderated from extremes found in tanks, and further there is a continuous flow of nutrients. Heat exchangers become fouled by microorganism growth, especially lactobacilli, and the growth forms a film that significantly reduces the efficiency of the heat exchangers. Treatment of only very small volumes of mash (that mash passing through the heat exchanger during the duration of the pulse) are needed, so the overall loading of antimicrobial agents to the total volume of mash is minimized.

Pulse treatment of heat exchangers with pre-dissolved antimicrobial agents of this invention will typically add a negligible amount of solvent to the mash volume. More stringent control of lactobacilli and/or other microorganisms is desired in heat exchangers. Such treatments can replace intermittent or continuous treatments added to large tanks but preferably supplement intermittent or continuous treatments added to large tanks. If the treatment of such heat exchangers is in addition to pulsed treatment of mixed tanks upstream of the heat exchangers, then advantageously at least some of the pulsed doses of antimicrobial agent directed only to the heat exchanger should be timed to coincide with the times of maximum concentration of active antimicrobial agent in the mash entering the pipes leading to the heat exchanger. Generally, the absolute amount of pristinamycin-type antimicrobial agents, polyether ionophores, or both added in a pulsed treatment of a heat exchanger is a small fraction of the amount of pristinamycin-type antimicrobial agents, polyether ionophores, or both added to large mixed tanks. A program of pulse treatment of a heat exchanger may result in treating only 1-5 percent of the mash, and this 1-5% is typically diluted by a factor of 20 to 100 when the pulse reaches the next large mixing vessel. If only 1 percent of the mash is treated in pulse treatment of heat exchangers, at a concentration of 4 ppm antimicrobial agent, then the added load of microbial agent to the total volume of mash (the average over the heat exchanger pulse treated mash and the untreated mash passing through a heat exchanger between doses) would be only 0.01 time 4 ppm or 0.04 ppm. If this 4 ppm pulse treatment of heat exchangers is made using solubilized antimicrobial agents in a solvent having 20% by weight of antimicrobial agent, then the solvent added to the total volume of mash will be only 0.2 ppm. However, a 4 ppm dosage rate is only used for severe entrenched contamination. The pulse treatment of heat exchangers will normally be adding 0.4 ppm of for example solubilized virginiamycin (which supplements the virginiamycin concentration from previous mixed tank treatments), and under the scenario discussed above the regular pulsed treatment of heat exchangers with solubilized virginiamycin would add only 0.004 ppm virginiamycin to the total mass of mash, and will only add 0.02 ppm of solvent to the total mass of mash. Use of solubilized antimicrobial agents to treat specific unit operations that have a low residence time will add a negligible amount of solvent to the mash.

Additionally, the concentration of pristinamycin-type antimicrobial agents, polyether ionophores, or both in the pulsed treatment can be very high, above 3.1 ppm, for example 4 or more ppm, where once the pulse reaches a large mixed tank the increase in antimicrobial agent concentration in the large mixed tank is instantly diluted to much less than 0.1 ppm.

For any production system, optimizing the pulse concentration, duration, and frequency is within the capabilities of one of ordinary skill in the art. Many benefits of this invention (faster active ingredient delivery) can be achieved by merely pre-wetting a prior art powdered pristinamycin-type antimicrobial agents or polyether ionophores in a solublizing solvent, particularly concentrated ethanol or an aprotic solvent, such that the solvent wets the powder and begins the dissolution process even as the powder is being added to the process, e.g., to the mash tanks. Alternatively, pristinamycin-type antimicrobial agents or polyether ionophores can be solubilized in solvent, and then admixed with water to form an emulsion or an aqueous composition with the solvent(s), e.g., polar aprotic solvents, and active pristinamycin-type antimicrobial agents or active polyether ionophores therein, and the emulsion or aqueous composition can be admixed with the material to be treated, e.g., mash.

Another aspect of this invention is to supply a source and pumping/dispensing unit, preferably a self-contained unit, which is to be attached via a feed line to for example in the pipe up-stream of for example a heat exchanger or to a vessel, and which supplies pulsed treatments, continuous treatments, or hybrid treatments of either or both of 1) the above-described liquid comprising pre-dissolved pristinamycin-type antimicrobial agents, pre-dissolved polyether ionophores, or both, or 2) the above-described slurry comprising micron to submicron particles of pristinamycin-type antimicrobial agents, polyether ionophores, or both, or combinations thereof, at a rate sufficient to obtain a pre-determined concentration in the mash flowing through the receiving pipe or vessel. The s source and pumping unit can be supplied with sensors which monitor heat exchanger performance, and which add a pulse of antimicrobial agent if degradation of the heat exchanger efficiency is detected. In its most simple embodiment, this source and pumping unit includes a metering pump (capable of pumping a known quantity of material into the mash) and a small reservoir for holding the antimicrobial agent. If the antimicrobial agent is added as a slurry and the slurry exhibits significant settling, then a mixer should be included in the reservoir. The complexity of the source and pumping unit can increase if the plant operators desire increased automation. Such automation is extremely valuable in saving operator work hours. The simplist automation is merely adding a timing mechanism to the pumping unit, where the timing mechanism can control the duration of a pulse, the frequency of a pulse, or both. For ethanol production plants where operations tend to be very steady-state, this is generally sufficient. For treatment of heat exchangers, simple temperature and flowrate sensors can monitor the efficiency of the heat exchanger, and a simple program can be made to treat the exchanger is undesired deterioration of the heat exchanger efficiency is detected. A failsafe mechanism can be added to the program which over rides the sensors and limits the frequency and duration of pulses, in the event that a sensor fails or that heat exchanger fouling is due to a problem other than microorganisms.

An additional benefit is certain solvents, expecially aprotic solvents such as DMSO, are known to be active in penetrating membranes. Carrying dissolved antimicrobial agents, and particularly pristinamycin-type antimicrobial agents, polyether ionophore-type antimicrobial agents, or both, said solvents may assist the agents in penetrating existing accumulations and films of biomass, and may thus help eradicate established accumulations of undesired biomass which are otherwise highly resistant to antimicrobial agents.

Another improvement over the simple reservoir and pumping/dispensing unit is to incorporate a mixer to provide high shear which will help dispense the antimicrobial agents into an aqueous medium. The mixer can actually contact the mash and mix the mash and injected pre-dissolved antimicrobial agents at the point where the antimicrobial agents are being added, but in this case special provisions may be required to allow for varying viscosity, temperature, and solids content of the mash. A less complicated but still effective device will be to add a small aqueous liquid source, e.g., water, water/ethanol, or the like, to the pumping/dispensing unit. A high shear mixer can be included on the pumping/dispensing unit. In this set-up the antimicrobial agent is added to a volume of the aqueous liquid under high shear, and the resulting composition is added to the mash immediately thereafter. The concentration of the antimicrobial agent dissolved in the organic liquid is beneficially made as high as practicable, so that shipping volumes and storing volumes are minimized. This aqueous liquid source under high shear is also very useful for adding supplemental slurried powdered antimicrobial agents, as the high shear can disrupt any protective coating added to stabilize the particles during storage, resulting in even faster particle dissolution. High shear at a mixing location will also prevent precipitation of antimicrobial agent at the point of mixing, which is useful if the injection point is a very small tube, and will aid in the formation of extremely small particles (or even of dispersed molecules) of the antimicrobial agent in the aqueous liquid, ensuring this condition when the resulting composition is added to the mass. That is, we believe adding organic liquid under high shear is very useful for dissolved antimicrobial agents, as adding the organic liquid containing the dissolved antimicrobial agent to a substantial excess of water (either in the mixer or in the mash) will result in dissipation of the solvent and resulting molecular or nanoparticles of antimicrobial agent. The presence of an aqueous liquid source in the pumping/dispensing unit is also useful as the material in the dispensing lines and injection nozzles (where the antimicrobial agent is actually added to mash) can be readily flushed with the aqueous liquid after each treatment. The amount of aqueous liquid added to the mash for each treatment would be negligible, e.g., between a cup and a few gallons is all that would be useful. Water is the preferred aqueous liquid, as it is readily available.

The use of this invention has a clear advantage of allowing automated control and dispensing of antimicrobial agents, thereby minimizing operator time, operator exposure, and potential errors associated with having the treatment be done manually.

Another aspect of this invention is to simultaneously add dissolved and slurried antimicrobial agents simultaneously or nearly simultaneously to mash. This pre-dissolved agent gives the injected fluid or slurry a small but almost instantaneous effect. The particles can provide the bulk of the antimicrobial agents over most of the duration of a pulsed dose. Such a mixture should be made immediately before adding it to the mash, as the solvent (if saturated with antimicrobial agents) will eventually over extended periods of time result in particle growth of particles in the slurry.

In each of the above-described embodiments the antimicrobial agent may comprise, consists essentially of, or consists of a pristinamycin-type antimicrobial agent. The term “pristinamycin-type antimicrobial agent” encompasses but is not limited to doricin, patricin, vernamycin, etamycin, geminimycin, synergistin, mikamycin, ostreogrycin, plauracin, streptogramin, pristinamycin, pyostacin, streptogramin, vernamycin, virginiamycin, viridogrisein, maduramycin, plauracin, and griseoviridin. However, the preferred antimicrobial agent of this type is virginiamycin, available for example from Phibro Animal Health Corp of Ridgefield Park, N.J. In each of the above-described embodiments the antimicrobial agent may comprise, consists essentially of, or consists of a polyether ionophore antimicrobial agent, a number of which are known in the art, and include for example lasalocid, maduramycin, monensin, narasin, salynomycin, and semduramycin, but the preferred polyether ionophore antimicrobial agents are monensin and semduramycin. The pristinamycin-type antimicrobial agent and polyether ionophore antimicrobial agents can be used in the various embodiments of this invention alone, together, or in combination with other antimicrobial agents including bactricin, penicillin, tetracycline, oxytetracycline, and the like.

While the invention is primarily useful for substantially water-insoluble pristinamycin-type antimicrobial agents and polyether ionophore antimicrobial agents, this invention is also useful for other antimicrobial agents and for blends. A variety of vendors market blends of antibiotics for treatment of microorganisms. Most blends include a number of agents and include agents to which microorganisms readily become resistant. Blends of agents that are not pristinamycin-type antimicrobial agents and/or polyether ionophore antimicrobial agents are not particularly preferred, as even if a blend comprises a pristinamycin-type antimicrobial agent or polyether ionophore antimicrobial agent, the amount of this agent is generally present in low amounts, increasing the risk of developing a resistant microorganism. Nevertheless, such blends can be readily accommodated by the methods and materials of this invention.

The preferred antimicrobial agents consist of, or consist essentially of, pristinamycin-type antimicrobial agents and/or polyether ionophore antimicrobial agents. The preferred dose, of used alone, is at least 0.25 ppm and preferably at least 0.3 ppm of pristinamycin-type antimicrobial agents or 0.4 ppm and preferably 0.5 ppm of polyether ionophore antimicrobial agents. A mixture of antimicrobial agents which makes sense from a scientific and economic standpoint is a mixture of pristinamycin-type antimicrobial agents and polyether ionophore antimicrobial agents. At least one of these should be added to the mash in its preferred effective dosage, but advantageously both can be added to mash at the lower ends of their preferred effective concentrations. This mixture includes only antimicrobial agents to which microorganisms rarely develop effective resistance, and the use of the two in combination provides different mechanisms of microorganism control and different efficiencies in the various environments (varying pH, sugar content, nutrients, contaminants, and the like present in the mash). Polyether ionophore antimicrobial agents are more readily solubilized by organic solvents, and therefore are more readily used when solubilized antimicrobial agents are desired. However, virginiamycin is the preferred antimicrobial agent, and its use in tanks is greatly preferred. If the solubilized antimicrobial agents are used only to treat limited operations, such as heat exchangers, the resulting mash in downstream mixed tanks in the production system may have a trace but not an effective amount of this agent. Solubilized antimicrobial agents added to treat small unit operations such as heat exchangers, and which add a very small amount of antimicrobial agent when viewed over the entire volume of mash in subsequent mixed tanks and fermentors, are beneficially of the same type of antimicrobial agent as are used to treat tanks.

The invention is intended to be illustrated by, but not limited to, the Examples described here.

### EXAMPLE 1

The solubility of monensin, virginiamycin, and similar pristinamycin-type antimicrobial agents and polyether ionophore-type antimicrobial agents in water is very low. Much more important, however, is the rate of dissolution of small granular pristinamycin-type antimicrobial agents and polyether ionophore-type antimicrobial agents in water. A 0.1 gram sample of a 5.2 to 10 micron average particle size virginiamycin was placed in a beaker with 4 liters of water, and the composition was continuously stirred. The presence of undissolved crystals was very evident. It took on the order of an hour before only a few crystals of the material remained visible.

The solubility of virginiamycin in several solvents were determined. Each of these solvents can be useful in solubilized organic liquid comprising antimicrobial material, an emulsion of the same in water, or in both. The results are presented in Table 1 below. It can be seen that we have surprisingly identified a number of solvents providing solubility in excess of 200 grams virginiamycin per liter of solvent, and even a formulation providing a solubility of over 300 grams per liter. Such a solution is stable, pumpable, and useful not only for treatments of ethanol-producing facilities but for a number of other uses where virginiamycin is used.

TABLE 1
Virginiamycin solubility in grams per liter of solvent

| | | |
|---|---|---|
| Methyl soyate ester | <1 | gram per liter |
| 2-ethyl hexyl lactate | ˜24 | grams per liter |
| Ethyl lactate | ˜92 | grams per liter |
| N,N-dimethylcapramide | ˜70 | grams per liter |
| 70% ethanol/30% water | ˜70 | grams per liter |
| N-methylpyrrolidone (NMP) ˜ | ˜260 | grams per liter |
| Dimethylsulfoxide (DMSO) | ˜270 | grams per liter |
| 50% NMP/50% DMSO | ˜335 | grams per liter |
| 50% NMP/50% Ethyl lactate | <200 | grams per liter |
| tetrahydrofurfuryl alcohol | <160 | grams per liter |

| | |
|---|---|
| 50% NMP/50% Ethyl lactate | forms a hard gel at 280 |
| | grams per liter. |

Gels including hard gels are also expected to be useful as the gel will dissipate rapidly when admixed into mash, especially at elevated temperature. In addition, literature data was obtained for the solubility of “virginiamycin-type” compounds in a variety of solvents, including dimethyl formamide (200 g/l), DMSO (>100 g/l), chloroform (not preferred) (150 g/l), dioxane (not preferred)(130 g/l), ethanol (70 g/l), methanol (25 g/l), acetone (˜190* g/l), isopropanol (>10 g/l), butanol (>10 g/l), methylethylketone (35 g/l), butyl acetate(3 5 g/l), ethyl acetate* (˜205 g/l), amylacetate (>4 g/l), benzene (>3 g/l), toluene* (82 g/l), ether* (11 g/l), hexane (0.2 g/l), carbon tetrachloride (0.02 g/l), 1% ethanol in water (0.002 g/l), and water (0.0002 g/l). Those solvents marked with an “*” had very disproportionate solubilities for the Type A and Type B components of virginiamycin, and are less suitable for preferred natural mixtures of virginiamycin having both type A and type B. Aprotic solvents such as NMP, dimethyl formamide, and DMSo show excellent solubilizing ability for the pristinamycin-type antimicrobial agents or polyether ionophores. Literature searches show monensin is much more soluble in a variety of solvents than is virginiamycin, and monensin is very soluble in ethyl acetate, acetone, chloroform, methanol, and even benzene.

### EXAMPLE 2

The issues in adding virginiamycin dissolved in a solvent are 1) what benefits are seen, and 2) are there detrimental effects? Tests were run to determine whether NMP in amounts which might be encountered in treating mash in an ethanol plant with solubilized antimicrobial agent would stress or otherwise adversely affect ethanol production from yeast. As previously discussed, under a number of treatment scenarios the amount of solvent used will expose yeast to perhaps 0.1 ppm of solvent, and we strongly suspected this amount will have no effect on yeast. However, this suspicion had to be proved.

The purpose of this experiment is to determine the efficacy of virginiamycin in three forms (DMSO-solubilized virginiamycin, Belgium powdered virginiamycin, and Brazilian powdered virginiamycin) in real corn mash fermentations against a consortium of Lactobacillus sp bacteria. No yeasts will be added. The efficacy of these forms of virginiamycin will be further tested in fermentors that will be properly (continuously) mixed and in fermentors that have improper mixing—simulating more closely the fermentor mixing conditions seen in field ethanol plants.

The first step in testing was the preparation of corn mash (i.e., Gelatinization, Liquefaction, and Saccharification). Sacks of yellow dent #2 corn (acquired from Early's Feed™, Saskatoon, SK, Canada) was frozen at −40° C. for a week to destroy any insects and eggs that may be present. An aliquot of corn (10 kg) was ground once in a S500 Disk Mill (Glen Mills Inc.,Clifton, N.J.) at setting #5 and stored frozen until the next day. Unless otherwise specified, all water used in the examples was reverse osmosis-treated water. About 17.5 liters of water was added to a 59 liter pilot plant steam kettle and heated to 60° C., followed by a 30 ml volume of Spezyme™ Ethyl alpha amylase (available from Genencor, Rochester, N.Y.). The 10 kg aliquot of ground corn was then added slowly with constant vigorous mixing with a motorized paddle. This mixing was maintained throughout the mashing procedure. The temperature in the steam kettle was incrementally increased from 60° C. to 96° C. in 10° C. increments with a 5 minute hold time at each increment. Once 96° C. was reached, the mixture was held for 60 minutes (to ensure complete gelatinization) and then cooled to 83° C. A second 30 ml dose of Spezyme™ Ethyl alpha amylase was added and the temperature maintained at 83° C. for 60 minutes.

The mash temperature was then decreased to 60° C. at which point 2 L water and 200 ml G-Zyme™ 480 Ethanol glucoamylase (available from Genencor, Rochester, N.Y.) were added. The mash was allowed to saccharify for 60 minutes. Aliquots of mash (4500 g) were dispensed into 5 pre-weighed 7.6 L polypropylene containers (containing large solid glass mixing marbles) and then autoclaved for 1.5 hours at 121° C. and 15 PSI. Tests for mash sterility were confirmed by incubating aliquots of mash for 5 months at room temperature and determining bacterial contamination with microbiological spread plates onto MRS media. No bacterial contamination was detected in any test incubated mashes.

For each 7.6 L sterile container of mash, a 60 g aliquot was removed and divided into two 30 g sub-samples within 50 ml centrifuge tubes. To one subsample, 10 ml RO water was added. After thorough mixing, both subsamples were centrifuged (10K RPM, 4° C., 20 minutes) in a Sorvall™ RC-5C centrifuge (Sorvall Instruments, Wilmington, Del.). The liquid supernatants were removed, and further clarified through Whatman 934-AH glass microfiber filters (Clifton, N.J.). The specific gravity of each subsample was then determined using a digital density meter (DMA-45; Anton Paar KG, Graz, Austria) which was temperature regulated to 4° C. If the readings on the density meter were off-scale, then a precise dilution of the subsamples were done and then re-read in the density meter. From the specific gravity the additional volume of sterile DO water that is required in each 7.6 L container to bring the dissolved solids concentration to 26% w/v was calculated. Sterile water was added aseptically to each 7.6 L sterile container of mash to achieve 26% w/v dissolved solids, and the samples were vigorously mixed. Then 1500 g aliquots of the mash from each 7.6 L container was aseptically dispensed into sterile 1.9 L containers, labeled with the mash batch number, date, and mash concentration, and frozen until needed. This accurate liquid volume was used in all calculations involving concentrations of added substances to the fermentor since approximately 30% of the total volume in the fermentor is insoluble material and does not participate as a solvent for dissolving chemicals.

For all bacterial experiments, a consortium of 6 industrially isolated and relevant Lactobacilli spp cultures were used. Three of the cultures (Coded: 18A, Rix20, Rix21) are representative of Lactobacilli frequently isolated from North American fuel ethanol plants. The remainder (coded: Rix22, Rix 83, Rix84), are Lactobacilli isolated from the field, but are not frequently found at fuel ethanol plants and exhibit stronger growth characteristics and higher fermentation stress tolerances. This experimental design using a consortium of bacteria better reflects the real world bacterial contamination occurring at a fuel ethanol plant—which is never a pure culture. Furthermore, using the “heartier” Lactobacilli, provided the experiments with the best “worst-case” scenario of contamination.

For four of the bacterial cultures (18A, Rix20, Rix21, Rix22), a loop of each was taken from a master slant and inoculated into a 250 ml Klett flask containing 100 ml MRS broth. For two of the bacterial cultures (Rix83, Rix84), 3 triplicate master slants were “washed” with either MRS broth (Rix83), or YEPD broth (Rix 84) and made up to a volume of 50 ml in respective Klett flasks and media. The headspace of all flasks were then flushed with sterile CO₂ for 1 minute. The cultures were incubated overnight in a rotary incubator at 30° C. at 150 RPM. The following morning the Klett reading of each culture was determined. If a Klett value for a particular culture was below 150, then the culture was pelleted by centrifugation, a volume of supernatant liquid was removed, and the pelleted culture resuspended in the remaining volume to give a more concentrated culture. Once all cultures showed a Klett value >150, then each culture was diluted accurately to 150 Klett, and subsequently diluted so that a 10 ml aliquot of each culture contained a desired initial dose (CFU/ml). For the experiments, the total CFU/ml in each fermentor was set to 5E5 CFU/ml. In this series of experiments, no yeasts were added to the fermentations. See the following example for yeast activity.

To each of 5 pre-sterilized Bioflo III fermentors (New Brunswick Scientific, Edison, N.J.), 4 L sterile mash was aseptically added and the total liquid in each fermentor was calculated. The fermentors were temperature controlled to 32° C. using the fermentor computers. Agitation (when on) was set for 150 RPM. The pH of the fermentors were not controlled and had an initial value of 4.6 (after addition of all chemicals). Once 32° C. was reached in the fermentors, the headspace of each fermentor was purged with sterile CO₂ at 40 mmin for 30 minutes to ensure that the entire fermentor (headspace and liquid) was anaerobic for inoculation. The purging was also continued during fermentation to maintain anaerobic conditions. The bacterial inocula was then added and allowed to adjust for 1 hour to the fermentor conditions. Following this, the addition of virginiamycin (in whatever form) was added to the appropriate fermentor to start the experiment. For the Lactrol™ (a virginiamycin-containing product available from Phibrochem Inc. Ridgefield, N.J.) additions, the required amounts were weighed to 4 decimal places in individual 3 ml glass screw-capped chromatograph vials. At the time of addition to the fermentors, 10 ml sterile distilled water in 2 ml aliquots “washings” were made for each vial into the fermentor to ensure quantitative transfer of all weighed material. For the additions of all forms of virginiamycin, the amounts to be added to each respective fermentor were calculated to give a 1 ppm virginiamycin level across all fermentors. To achieve this, the amount of Lactrol™ (two Lactrols™ were tested—one source from Belgium and one source from Brazil) required to be added to the appropriate fermentor was 4.549 mg while for the DMSO-solubilized virginiamycin-treated fermentors, the amount of DMSO-solubilized virginiamycin (containing 270 g virginiamycin/L) required to be added was 8.40 μl. To each fermentor also was added:10 ml 0.2 μm filter-sterilized Urea stock solution (providing 8 mM urea in fermentors), 60 ml (6 cultures×10 ml per culture) Bacterial inocula, and 40 ml sterile water.

For each set of conditions fermentation tests were run in duplicate. Two experimental conditions were tested, simulating a well-mixed tank and a poorly mixed tank. For the fermentors in the well mixed condition, the mixing of the fermentor was kept constant at 150 RPM. For the fermentors in the poorly mixed condition, the fermentor mixing was turned on for 10 seconds at 150 RPM to mix the contents of the fermentor, the appropriate samples were taken, and then the mixing was turned off for 12 hours. This poorly-mixed condition was judged to simulate real conditions (or even to be better than real conditions) as the experimental fermentators only contained 4 liters of mash each. The Improper mixing fermentors simulate the conditions found in field ethanol plants where it is not uncommon for fermentors to not be mixed properly (residence times vary from 1 hour to 12 hours depending on flow and fermentor sizes), or have sediments/biofilms where antimicrobial chemicals cannot easily reach.

Samples (33 ml) from the fermentors were collected and placed on ice to prevent growth. An 11 ml aliquot of each sample was serially diluted in 0.1% w/v sterile peptone water, and microbiologically plated onto MRS agar in duplicate. All plates were incubated for 48 h at 30° C. in an anaerobic CO₂ incubation chamber, and manually enumerated for viable Lactobacilli. The remaining 22 ml aliquot of each sample was centrifuged (10K RPM, 4° C., 20 minutes) in a Sorvall RC-5C centrifuge. The liquid supernatant was then passed through a 0.2 μm membrane filter to remove any particulates and frozen. Then, lactic acid, glycerol, ethanol, acetic acid, and glucose concentrations were determined by HPLC analysis. The samples were thawed and diluted to the required extent with Milli-Q water. Aliquots of the diluted samples (100 μl) were each mixed with an equal volume of 2% w/v boric acid (internal standard), and injected into a Biorad HPX-87H Aminex column equilibrated at 40° C. The eluent was 5 mM sulfuric acid flowing at a rate of 0.7 ml/min. The components were detected by a differential refractometer (Model 4210, Waters Chromatographic Division, Milford, Mass.) and the subsequent data processed by the supplied Waters Millenium32 software.

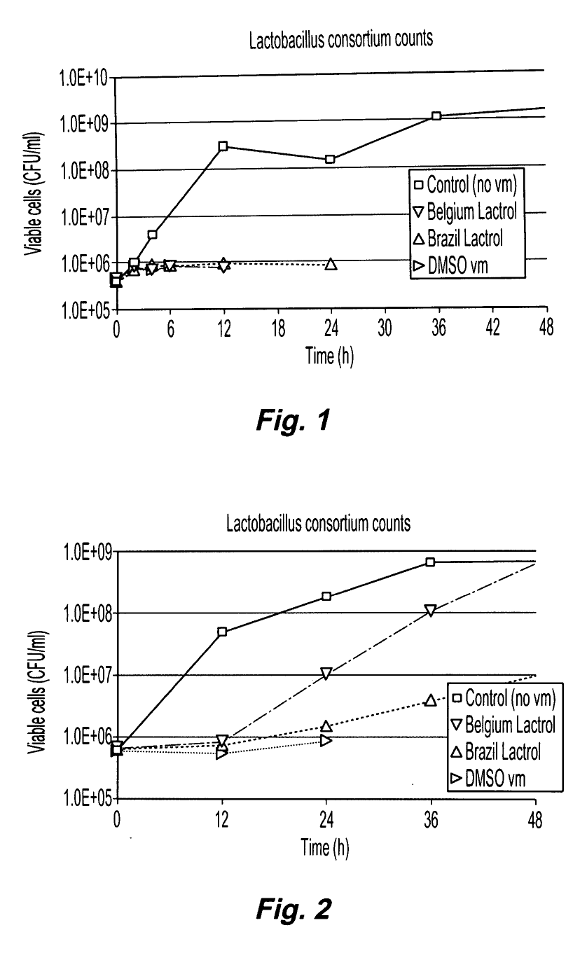

FIG. 1 shows the Lactobacillus count versus time in mash from the well-mixed fermentators treated with Lactrol™ (Brazil) brand virginiamycin, Lactrol™ (Belgium) brand virginiamycin, virginiamycin solubilized in DMSO according to this invention, , and also the Lactobacillus count in a well-mixed control fermentator. As expected, the addition of 1 ppm virginiamycin to fermentors which were well mixed prevented the growth of the Lactobacillus consortium (CFU/ml did not exceed 1 E6). This lack of differentiation was expected, as the benefits of pre-solubilizing the antimicrobial agent would be expected to be minimal in small 4 L fermentators mixed at 150 RPM with mixer paddles. Such rapid mixing would tend to solubilize powdered virginiamycin in an hour or so. The pre-DMSO-solubilized virginiamycin in well-mixed fermentators showed efficacy equal to (and in the initial 4 hours perhaps slightly better than) that of the Lactrol™ brand powdered virginiamycin products. In contrast the Lactobacillus consortium in the control condition increased by 4000 fold from the time of inoculation (5E5 CFU/ml) to 48 h (2E9 CFU/ml). Lactic acid content of the mash in the control increased over time, reaching 0.8% wt/v. Substantially no lactic acid production was observed in any of the virginiamycin-treated mashes at any time. Glucose analyses were inconclusive, as the scatter in data overshadowed any small changes we were expecting.

Although no differences were seen in the degree of control of lactic acid production in the well-mixed fermentators, differences did exist in the time taken for the virginiamycin in each case to eliminate all detectable viable Lactobacillus from the fermentors. For example, for the Brazilian lactrol™ brand virginiamycin, no detectable viable Lactobacillus were found in the fermentors after 24 hours. For the Belgium lactrol™ brand virginiamycin, no detectable viable Lactobacillus were found after 12 hours. However, for DMSO-presolubilized virginiamycin, no detectable viable Lactobacillus were found after only 6 hours. DMSO-solubilized virginiamycin provided the same degree of control as the other forms of virginiamycin used, but was much faster in destroying the controlled bacteria than the other forms of virginiamycin. This means that while Lactrol™ brand powdered virginiamycin treatments upon addition were eventually effective in halting growth of the lactobacilli consortium (maintaining a bacteristatic condition) in well-mixed fermentators, the DMSO-solubilized virginiamicin was more effective in destroying the consortium as the time needed to reduce viable lactobacilli was six hours compared to 12 to 24 hours for the powdered virginiamycin.

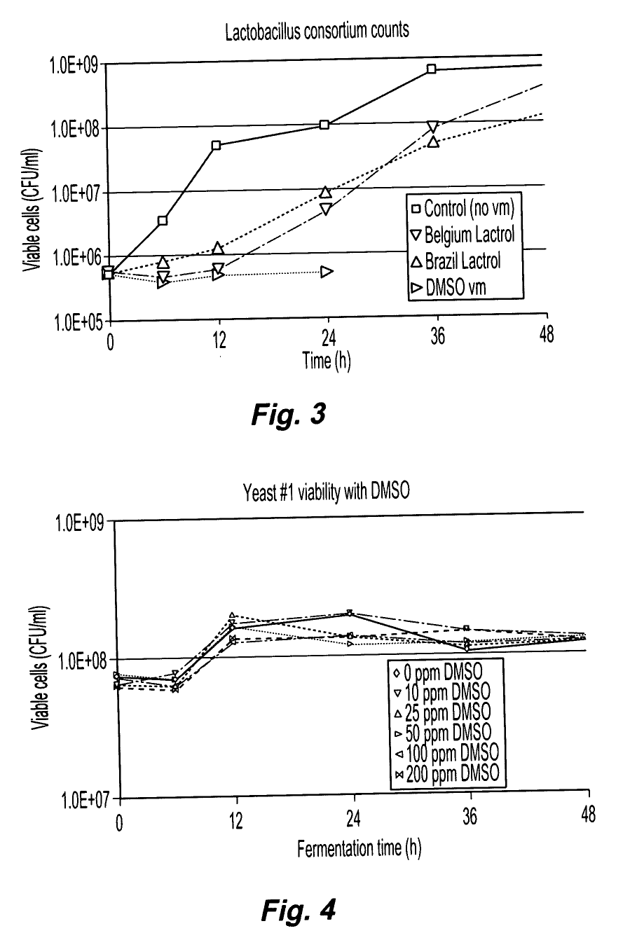

FIGS. 2 and 3 show (for duplicate experiments) the Lactobacillus count versus time in mash from the poorly-mixed fermentators treated with Lactrol™ (Brazil) brand virginiamycin, Lactrol™ (Belgium) brand virginiamycin, virginiamycin solubilized in DMSO according to this invention, and in a poorly-mixed control fermentator. The pre-DMSO-solubilized virginiamycin exhibited clearly superior control of the Lactobacilli in poorly mixed fermentators than did either of the powdered virginiamycin products. This is true despite the powdered products being exposed to 10 seconds of vigourous mixing immediately after introducing the powders to sufficiently disperse the powders. The mash treated with the pre-DMSO-solubilized virginiamycin was substantially bacteriostatic, while mashes treated with powdered products exhibited continually increasing lactobacilli counts. We believe the solubilized pristinamycin-type antimicrobial agents and polyether ionophores, and particularly DMSO-solubilized virginiamycin, may have a penetrating power and therefore a remedial affect on biofilms. It is known, for example, that the dipolar hydroscopic solvent DMSO has high penetrating ability through various membranes.

In the poorly mixed fermentors, lactic acid concentration in untreated control mashes increased almost linearly with time, reaching 0.50 and 0.58 Wt. %/v in 48 hours in duplicate experiments. In the poorly mixed fermentors treated with powdered virginiamycin product from Belgium, lactic acid reached 0.29 and 0.48 Wt. %/v in 48 hours in duplicate experiments. Much better control was exhibited by the powdered virginiamycin product from Brazil, as the mash in the poorly mixed fermentors reached only 0.02 to 0.19 Wt. %/v in 48 hours in duplicate experiments. But the best control was observed in the mashes in poorly mixed reactors treated with pre-DMSO-solubilized virginiamycin, as no detectable lactic acid was found after 48 hours.

As in the properly mixed fermentors, the DMSO-pre-solubilized virginiamycin provided a consistent degree of control of the consortium (no multiplication), and also demonstrated complete destruction of the consortium. The only difference between the properly and improperly mixed fermentors was total destruction of the bacteria took only 6 hours for the properly mixed fermentors, while it took 24 hours to achieve the same effect in the improperly mixed fermentors. DMSO-pre-solubilized virginiamycin was the only product that both controlled and killed the consortium bacteria in fermentors where mixing was not thorough.

There were differences in the efficacy of the powdered Lactrol™ products. We are not certain what practical significance this has on the two products for a fuel ethanol plant, since by the time the fermentation reaches 12 hours, the yeasts have adjusted to the fermentor and the yeasts begin to inhibit the lactobacilli. The fact that the pre-solubilized antimicrobial agent, e.g., virginiamycin, both control and kill at least 90% lactobacilli within 6 hours provides a very practical advantage and efficacious at ethanol plants as the yeasts are typically still adjusting to the environment in the fermentor.

### EXAMPLE 3

Dialkylsulfoxides and alkyl pyrrolidones, where the alkyl groups are independently C1 to C4, are particularly preferred. Dimethylsulfoxide (DMSO) and N-Methyl-2-Pyrrolidone (M-Pyrol or NMP) compatibility with yeast corn mash fermentations were evaluated with two yeasts (Yeast#1 and Yeast#2) commercially used in the fuel ethanol industry. Concentrations of 0 to 1200 ppm of either solvent were added at the beginning of dry-milled corn-mash fermentations along with either yeast. For the entire course of fermentation, the growth (viability) of the yeasts at any concentration of either solvent did not significantly differ from the corresponding controls (without solvent). Yeast stress did not increased at any solvent concentration used during fermentation—as evidenced by the lack of glycerol increase (a stress indicator for yeast) as compared to the controls. Furthermore, glucose consumption proceeded normally for both yeasts under all conditions. Ethanol yields for all conditions showed the expected amounts except in the case for M-Pyrol with Yeast #2. In this case the ethanol concentration at M-Pyrol concentrations >400 ppm clearly showed a consistent trend towards lower concentrations of ethanol as the M-Pyrol concentration increased. However, both solvents (or a mixture of the two) are compatible with yeasts if used delivering pristinamycin-type antimicrobial agents and/or polyether ionophores in a pre-solubilized form during corn-mash fermentation. The solubility of pristinamycin-type antimicrobial agents and/or polyether ionophores in DMSO and in NMP is about 250 g/L, so to dose a mash or liquor with 1 ppm of pristinamycin-type antimicrobial agents and/or polyether ionophores in a 750,000 gallon ICM fermentor would require under 2 gallons of DMSO (containing 1564.5 g solubilized virginiamycin) to the fermentor. This would make the DMSO content of the fermentor to be less than 2 gal/750,000gal of mash or less than 3 ppm total solvent. Therefore, the adverse effects on ethanol production at 400 ppm solvent or greater are not pertinent to use of M-Pyrol in delivering for example virginiamycin to a corn mash.

Sterile saccharified 26% wt. %/v corn mash was prepared using substantially the same procedure described in Example 2. To each of 6 pre-sterilized Celstir™ fermentors (Wheaton Instruments, Millville, N.J.), 500 g sterile mash was aseptically added. The fermentors were temperature controlled to 32° C. using circulating water baths (Haake D8;G, Berlin, Germany) to pump water through the jackets of the Celstir fermentors. Magnetic stirrers (IKA-Lavortechnik, Staufen, Germany) were used to mix the fermentors at approximately 200 RPM. The pH of the fermentors were not controlled and had an initial value of 4.6 (after addition of all chemicals). Then, to each fermentator was added 1) 1 ml of 0.2 μm filter-sterilized Urea stock solution (8 mM urea in fermentors); 2) 1 ml filter sterilized aqueous DMSO (Gaylord Chemical, CAS#67-68-5) or aqueous M-Pyrol (ISP, CAS#872-50-) solutions; and 3) 1.027 g Yeast#1 or Yeast#2 commercial active dry yeasts in 18 ml sterile water.

Testing and analysis were also similar to that described in Example 2. Samples (22 ml) were taken at 0, 6, 12, 24, 36, and 48 h and placed on ice to prevent growth. An 11 ml aliquot of each sample was serially diluted in 0.1% w/v sterile peptone water, and microbiologically plated onto MRS agar plates in duplicate. All plates were incubated for 48 h at 30° C. in an anaerobic CO₂ incubation chamber, and manually enumerated for viable Lactobacilli. The remaining 11 ml aliquot of each sample was centrifuged (10K RPM, 4° C., 20 minutes) in a Sorvall RC-5C centrifuge. The liquid supernatant was then passed through a 0.2 μm membrane filter to remove any particulates and frozen for future analysis. Lactic acid, glycerol, ethanol, acetic acid, and glucose concentrations were determined by HPLC analysis. The samples were thawed and diluted to the required extent with Milli-Q water. Aliquots of the diluted samples (100 μl) were each mixed with an equal volume of 2% w/v boric acid (internal standard), and injected into a Biorad HPX-87H Aminex™ column equilibrated at 40° C. The eluent was 5 mM sulfuric acid flowing at a rate of 0.7 ml/min. The components were detected by a differential refractometer (Model 4210, Waters Chromatographic Division, Milford, Mass.) and the subsequent data processed by the supplied Waters Millenium32 software. All fermentations were performed in duplicate.

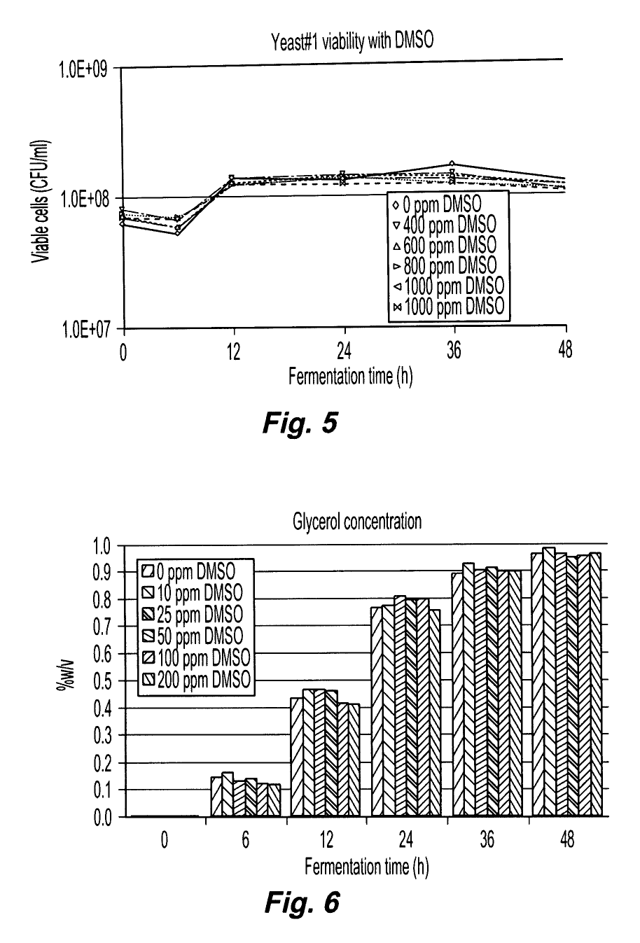

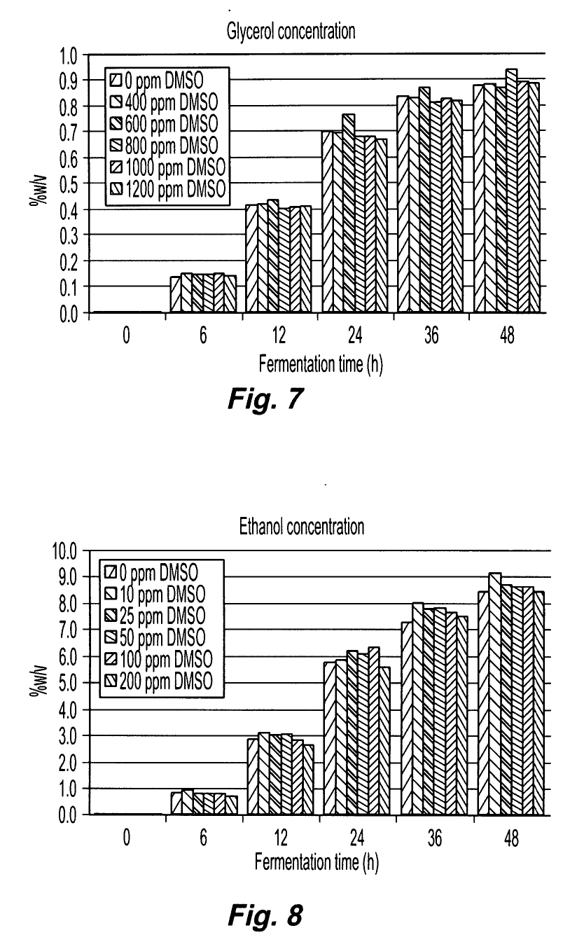

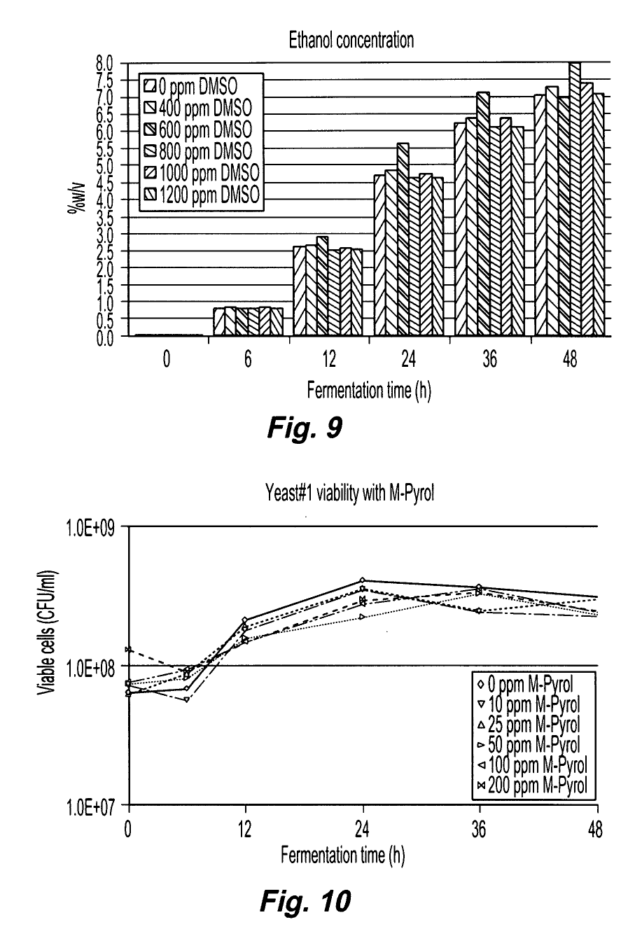

The tests described in Example 3 were performed at extremely high concentrations of the solvents DMSO and NMP to exaggerate any effects the solvents might have had on the yeast. As discussed previously, typical treatments of antimicrobial agents, and particularly pristinamycin-type antimicrobial agents or polyether ionophores. FIGS. 4 and 5 show Yeast #1 viability in corn mash containing 0 to 200 ppm DMSO and 0 to 1000 ppm DMSO, respectively. FIGS. 6 and 7 show glycerol production from Yeast #1 in corn mash containing 0 to 200 ppm DMSO and 0 to 1200 ppm DMSO, respectively. It can be seen in the data that even 1000 ppm of DMSO does not appear to affect the viability of Yeast #1 or stress Yeast #1 even after 48 hours of exposure. During normal use with this invention, total solvent added (which can be DMSO and/or other solvents) to the mash to carry pre-solubilized biological control agents is expected to be less than 10 ppm. FIGS. 8 and 9 show ethanol production from Yeast #1 in corn mash containing 0 to 200 ppm DMSO and 0 to 1200 ppm DMSO, respectively. As anticipated, the DMSO did not inhibit ethanol production.

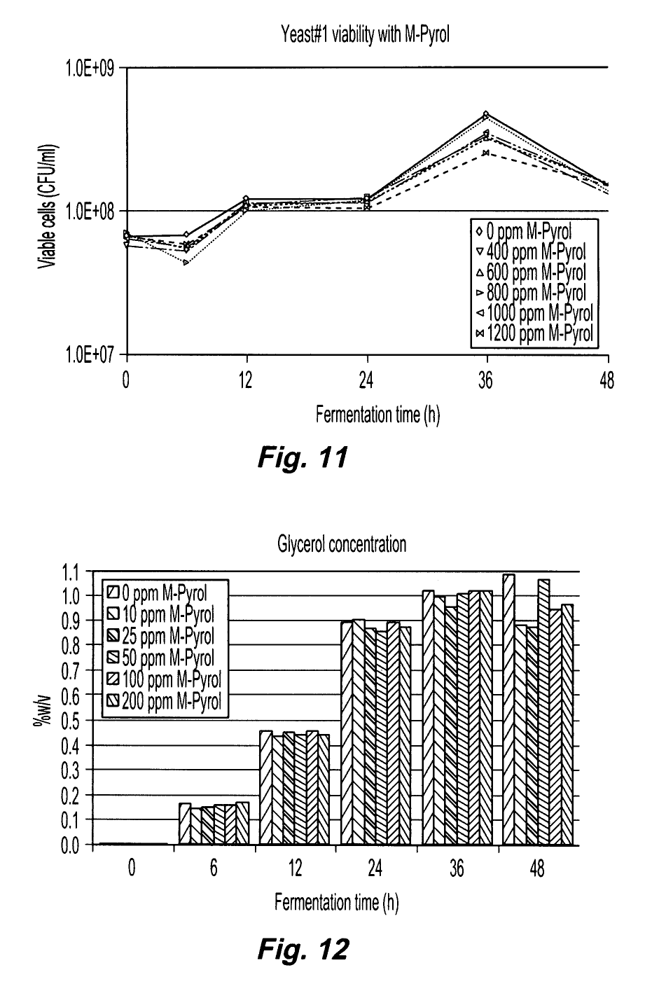

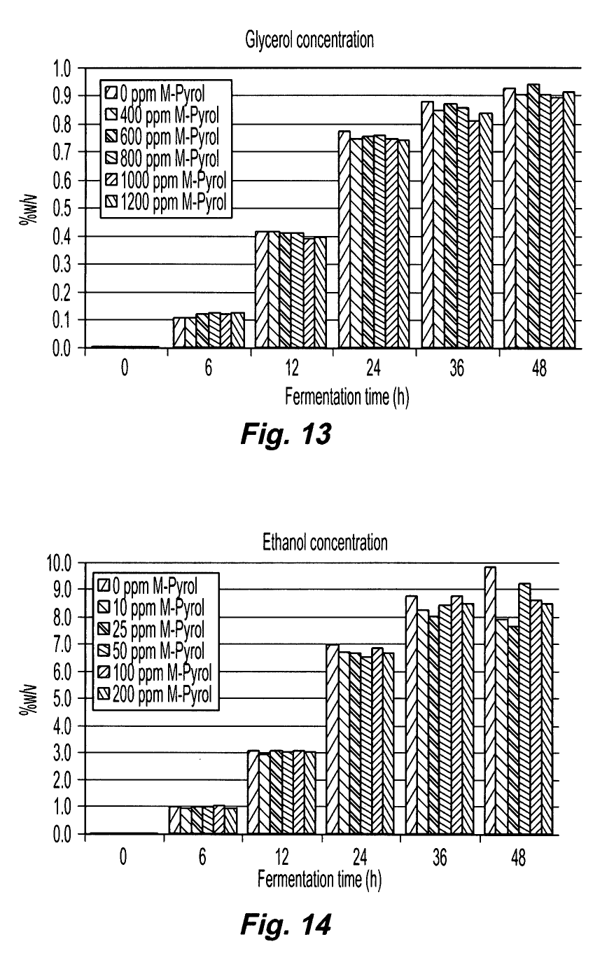

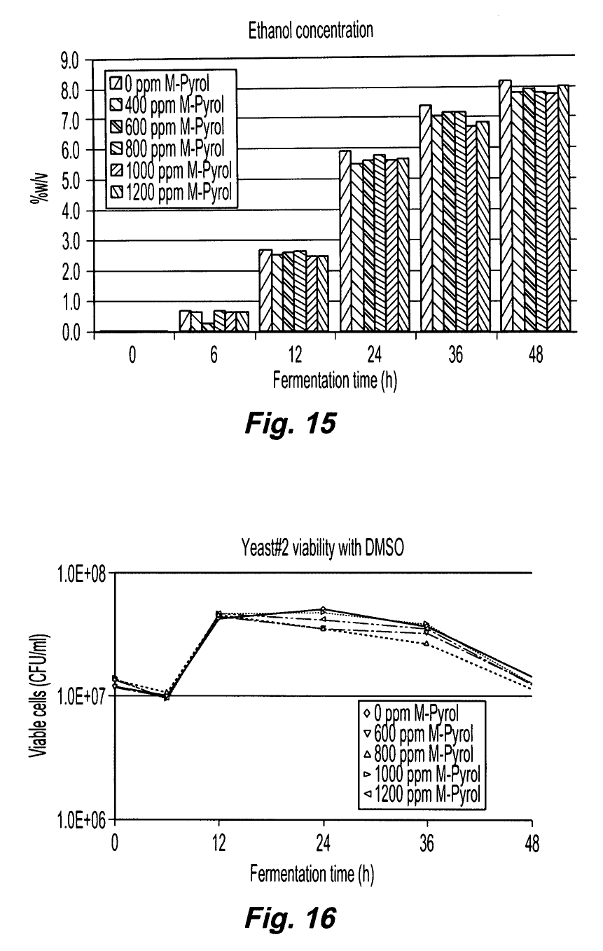

FIGS. 10 and 11 show Yeast #1 viability in corn mash containing 0 to 200 ppm NMP (M-pyrol) and 0 to 1200 ppm NMP, respectively. FIGS. 12 and 13 show glycerol production from Yeast #1 in corn mash containing 0 to 200 ppm NMP and 0 to 1200 ppm NMP, respectively. There is a slight decline in yeast viability at NMP concentrations above 400 ppm. FIGS. 14 and 15 show ethanol production from Yeast #1 in corn mash containing 0 to 200 ppm NMP and 0 to 1200 ppm NMP, respectively. Again, there was a slight decline in ethanol production from yeast #1 with increasing NMP, from 8.1% in the control to 7.8% at 1000 ppm NMP.

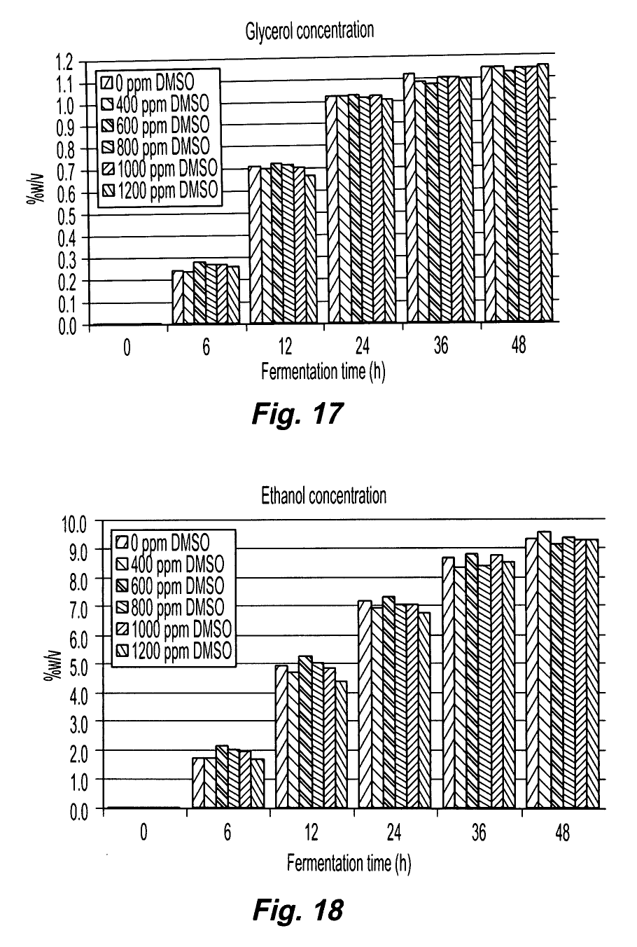

FIG. 16 shows Yeast #2 viability in corn mash containing 0 to 1200 ppm DMSO. FIG. 17 shows glycerol production from Yeast #2 in corn mash containing 0 to 1200 ppm DMSO. FIG. 18 shows ethanol production from Yeast #2 in corn mash containing 0 to 1200 ppm DMSO. Again, DMSO has no adverse effect on yeast performance, even when there is two orders of magnitude greater concentration present than is anticipated to be added during the practice of this invention.

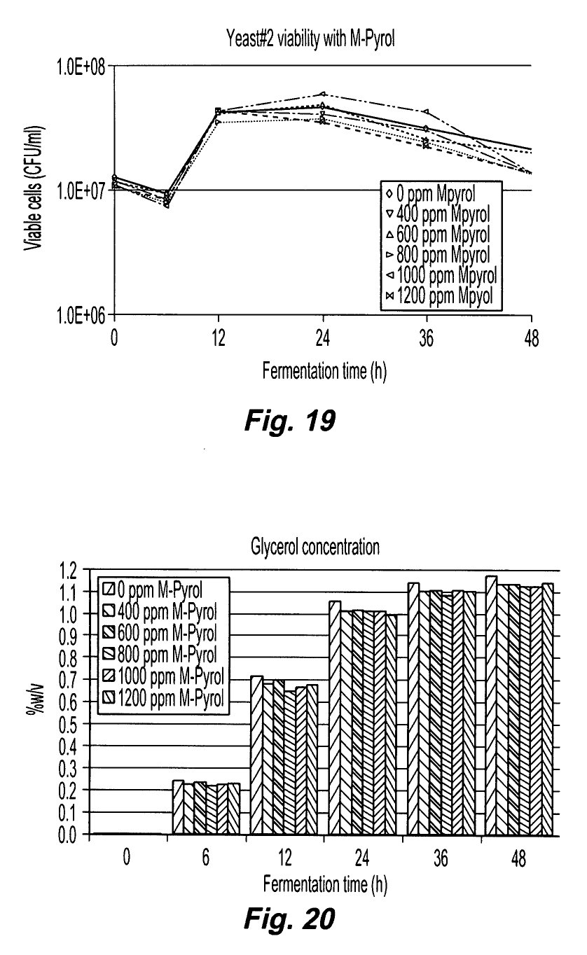

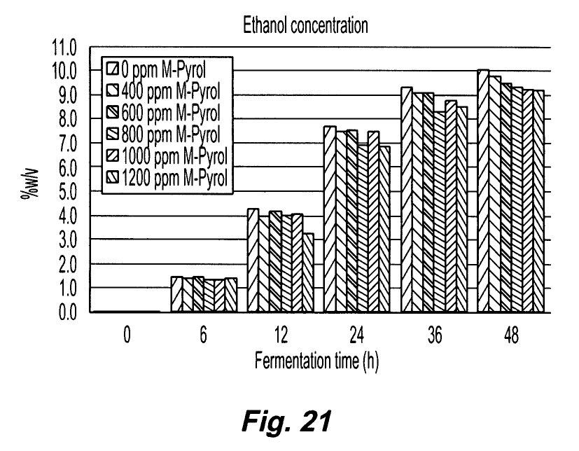

FIG. 19 shows Yeast #2 viability in corn mash containing 0 to 1200 ppm NMP. FIG. 20 shows glycerol production from Yeast #2 in corn mash containing 0 to 1200 ppm NMP. FIG. 21 shows ethanol production from Yeast #2 in corn mash containing 0 to 1200 ppm NMP. The decline in yeast performance with increasing concentration of NMP is clear, where the control with no NMP provided 10% ethanol in 48 hours while the sample having 1000 ppm NMP provided only 9.1% ethanol in 48 hours. Yeast #2 is more highly affected by the presence of NMP than was yeast #1, though at likely use levels following the methods of this invention even the effect of NMP on yeast #2 is expected to be negligible.

Only particular aspects of the invention are illustrated by the above examples, and the invention is not intended to be limited to the Examples.

1. A method of controlling lactobacilli metabolism in mash in an ethanol production facility, comprising adding to the mash a treating liquid comprising:
1) at least one organic solvent, and
2) a substantially water insoluble pristinamycin-type antimicrobial agent, a substantially water insoluble polyether ionophore antimicrobial agent, or both, dissolved therein, wherein the term “substantially water insoluble” means the antimicrobial agent has a solubility in pure water at 20° C. of about 0.1 grams per liter or less, and said organic liquid comprises more than 1 gram per liter of said antimicrobial agent(s) dissolved therein.

2. The method of claim 1, wherein the substantially water insoluble antimicrobial agent comprises virginiamycin, semduramycin, or both.

3. The method of claim 1, wherein the substantially water insoluble antimicrobial agent comprises monensin.

4. The method of claim 1, wherein the organic liquid comprises at least one dipolar aprotic organic solvent, wherein said treating liquid comprises more than 10 grams per liter of said pristinamycin-type antimicrobial agent.

5. The method of claim 1, wherein the organic liquid comprises a dialkyl sulfoxide, and alkyl pyrrolidones, or both, wherein the alkyl groups are independently C₁ to C₄, wherein said treating liquid comprises more than 10 grams per liter of said pristinamycin-type antimicrobial agent.

6. The method of claim 1, wherein the substantially water insoluble antimicrobial agent comprises a substantially water insoluble pristinamycin-type antimicrobial agent.

7. The method of claim 6, wherein said treating liquid comprises more than 10 grams per liter of said pristinamycin-type antimicrobial agent.

8. The method of claim 6, wherein said treating liquid comprises more than 50 grams per liter of said dissolved pristinamycin-type antimicrobial agent.

10. The method of claim 6, wherein said treating liquid comprises more than 100 grams per liter of said dissolved pristinamycin-type antimicrobial agent.

11. The method of claim 1, wherein the substantially water insoluble antimicrobial agent comprises a substantially water insoluble polyether ionophore-type antimicrobial agent.

12. The method of claim 11, wherein said treating liquid comprises more than 10 grams per liter of said polyether ionophore-type antimicrobial agent.

13. The method of claim 11, wherein said treating liquid comprises more than 50 grams per liter of said dissolved polyether ionophore-type antimicrobial agent.

14. The method of claim 11, wherein said treating liquid comprises more than 100 grams per liter of said dissolved polyether ionophore-type antimicrobial agent.

15. The method of claim 1, wherein the organic solvent comprises at least an alkyl acetate, an alkyl lactate, or combination thereof, said treating liquid comprising more than 50 grams per liter of said antimicrobial agent.

16. The method of claim 1, wherein the organic solvent comprises a C₁ to C₅ alkyl ester of a C₁ to C₄ organic acid, alkyl acetate where the alkyl moiety has between 1 and 4 carbon atoms, alkyl lactate where the alkyl moiety has between 1 and 4 carbon atoms, N,N-dialkylcapramide where the alkyl moiety has between 1 and 4 carbon atoms, dialkylsulfoxide where the alkyl moieties have independently between 1 and 4 carbon atoms, N-alkylpyrrolidone where the alkyl moiety has between 1 and 4 carbon atoms, pyrrolidone, dialkyl formamide where the alkyl moiety has between 1 and 4 carbon atoms, acetone, isopropanol, a butanol, a pentanol, or combinations thereof.

17. The method of claim 1, wherein the treating liquid comprising at least 70% by weight of ethanol.

18. The method of claim 1, wherein the treating liquid comprises at least one dipolar aprotic organic solvent, at least one alkyl acetate, at least one alkyl lactate, or combination thereof, said treating liquid comprising more than 20 grams per liter of said antimicrobial agent.

19. The method of claim 1, wherein the substantially water insoluble antimicrobial agent comprises a substantially water insoluble pristinamycin-type antimicrobial agent, and wherein the organic solvent comprises at least one alkyl acetate or alkyl lactate wherein the alkyl moiety contains between 1 and 4 carbon atoms.

20. The method of claim 1, wherein the organic solvent comprises a pyrrolidone, an amide, or a sulfoxide.

21. The method of claim 1, wherein the treating liquid comprises at least 200 grams of said dissolved antimicrobial agent per liter.

22. The method of claim 1, wherein the organic solvent has a closed cup flash point of greater than 200° F.

23. The method of claim 1, wherein the ethanol production facility comprises a tank having an inlet and an outlet and a heat exchanger having an inlet and an outlet and being flowingly connected to the outlet of said tank so mash flows from the tank to the heat exchanger, the method comprising adding to the mash at a point between the tank outlet and the outlet of the heat exchanger said treating liquid comprising more than 10 grams per liter of said antimicrobial agent(s).

24. The method of claim 1, wherein said treating liquid is added by a metering pump which pumps the treating liquid into said mash.

25. The method of claim 1, wherein the organic solvent comprises dimethylsulfoxide.

26. The method of claim 1, wherein the organic solvent comprises N-methyl-2-pyrrolidone.

27. The method of claim 1, wherein the antimicrobial agent consists essentially of a substantially water insoluble pristinamycin-type antimicrobial agent, a substantially water insoluble polyether ionophore antimicrobial agent, or both.

28. The method of claim 1, wherein the treating liquid comprises more than 50% by weight of one or more organic solvents.

29. The method of claim 1, wherein the treating liquid is added to an aqueous liquid which can be water or mash, wherein the treating liquid is added to the aqueous liquid under high shear such that dissipation of the solvent results in molecular antimicrobial agent or nanoparticles of antimicrobial agent.

30. The method of claim 1, wherein adding to the mash a treating liquid eradicates established accumulations of lactobacilli, wherein adding an identical concentration of powdered antimicrobial agent will not eradicate the established accumulations of lactobacilli.

31. The method of claim 1, wherein the antimicrobial agent consists essentially of virginiamycin, semduramycin, monensin, or any combination thereof.

32. The method of claim 1, wherein the treating liquid is in the form of a gel at room temperature.

33. A method of eradicating lactobacilli in mash in an ethanol production facility, comprising adding to the mash a treating liquid comprising:
1) at least one organic solvent, and
2) a substantially water insoluble pristinamycin-type antimicrobial agent, a substantially water insoluble polyether ionophore antimicrobial agent, or both, dissolved therein, wherein the term “substantially water insoluble” means the antimicrobial agent has a solubility in pure water at 20° C. of about 0.1 grams per liter or less, and said organic liquid comprises more than 1 gram per liter of said antimicrobial agent(s) dissolved therein, wherein within 6 hours of adding the treating liquid to the mash at least 90% lactobacilli originally present are no longer viable.

34. The method of claim 33 wherein the antimicrobial agent consists essentially of virginiamycin, semduramycin, monensin, or any combination thereof.

35. A method of controlling undesired microorganisms in mash in an ethanol production facility, comprising adding to the mash a treating liquid comprising:
1) at least one organic solvent, and
2) a substantially water insoluble pristinamycin-type antimicrobial agent, a substantially water insoluble polyether ionophore antimicrobial agent, or both, dissolved therein, wherein the term “substantially water insoluble” means the antimicrobial agent has a solubility in pure water at 20° C. of about 0.1 grams per liter or less, and said organic liquid comprises more than 1 gram per liter of said antimicrobial agent(s) dissolved therein.
